(19) United States
(12) Patent Application Publication
(10) Pub. No.: US 2013/0074076 A1
(43) Pub. Date: Mar. 21, 2013

(54) AUTOMATIC TASK MANAGEMENT AND RESOLUTION SYSTEMS AND METHODS

(71) Applicants: Yoni LINDENFELD, Ramat Hasharon (IL); Omer PERCHIK, Rosh Ha'ayin (IL); Itay KAHANA, Gan Yavne (IL)

(72) Inventors: Yoni LINDENFELD, Ramat Hasharon (IL); Omer PERCHIK, Rosh Ha'ayin (IL); Itay KAHANA, Gan Yavne (IL)

(73) Assignee: ANY.DO INC., Palo Alto, CA (US)

(21) Appl. No.: 13/235,935

(22) Filed: Sep. 19, 2011

(51) Int. Cl. G06F 9/46

(52) U.S. Cl. 718/100

(57) ABSTRACT

An automatic task management and resolution system including semantic task analysis functionality operative to provide a semantic analysis of at least part of a textual description of a task and task-resolution functionality operative to employ the semantic analysis to recommend at least one resolution for the task. The task-resolution functionality is also operative to prompt an owner of the task to select one of at least one resolution for the task and to execute the one of at least one resolution for the task.

### FIELD OF THE INVENTION

The present invention relates generally to automatic task management and resolution systems and methods.

### BACKGROUND OF THE INVENTION

The following patents and patent publications are believed to represent the current state of the art:
U.S. Pat. Nos. 6,680,675 and 7,484,179; and
U.S. Published Patent Application Nos.: 2006/0282835; 2007/0282658 and 2008/0301296.

### SUMMARY OF THE INVENTION

The present invention seeks to provide automatic task management and resolution systems and methods.

There is thus provided in accordance with a preferred embodiment of the present invention an automatic task management and resolution system including semantic task analysis functionality operative to provide a semantic analysis of at least part of a textual description of a task and task-resolution functionality operative to employ the semantic analysis to recommend at least one resolution for the task.

In accordance with a preferred embodiment of the present invention the task-resolution functionality is also operative to prompt an owner of the task to select one of at least one resolution for the task. Preferably, the task-resolution functionality is also operative to execute the one of at least one resolution for the task. Preferably, the automatic task management and resolution system also includes a task database operable for storing task descriptions and metadata associated therewith.

Preferably, the automatic task management and resolution system also includes auto-complete functionality operative to employ the semantic analysis to preemptively suggest at least one complementary text to complete the at least part of a textual description of a task. Preferably, the at least one complementary text includes a task predicate with whom an owner of the task has interacted in the past. Additionally or alternatively, the at least one complementary text includes a task predicate with whom an owner of the task is acquainted. Preferably, the auto-complete functionality retrieves the predicate from at least one of the owner's phone contacts, the owner's social network contacts and public contact directories. Additionally, the at least one complementary text includes at least a refining term which refines the textual description of the task. Preferably, the auto-complete functionality is also operative to prompt an owner of the task to select one of at least one complementary text to complete the at least part of a textual description of a task.

Additionally or alternatively, the automatic task management and resolution system also includes auto-complete functionality operative to utilize task descriptions stored in the database to preemptively suggest at least one complementary text to complete the at least part of a textual description of a task. Preferably, the at least one complementary text includes a task predicate with whom an owner of the task has interacted in the past. Additionally or alternatively, the at least one complementary text includes a task predicate with whom an owner of the task is acquainted. Preferably, the auto-complete functionality retrieves the predicate from at least one of the owner's phone contacts, the owner's social network contacts and public contact directories. Additionally, the at least one complementary text includes at least a refining term which refines the textual description of the task. Preferably, the auto-complete functionality is also operative to prompt an owner of the task to select one of at least one complementary text to complete the at least part of a textual description of a task.

Preferably, the automatic task management and resolution system also includes a statistics aggregator operable for aggregating task statistics.

In accordance with a preferred embodiment of the present invention the task-resolution functionality includes at least one of a contextual assistant operative to employ the semantic analysis to recommend at least one contextual resolution for the task, the contextual resolution being contextually related to the task, a personalization engine operative to employ the semantic analysis and personal information pertaining to an owner of the task to recommend at least one personalized resolution for the task, a task collaboration platform operative to employ the semantic analysis to recommend collaborating between at least two individuals to resolve the task, a task delegation engine operative to employ the semantic analysis to delegate resolving of the task to an individual other than the owner and a subtasking engine operative to employ the semantic analysis to break down the task into a set of subtasks and to employ the task resolution matching functionality to recommend a resolution for each of the subtasks.

Preferably, the personal information includes at least one of the location of the owner, preferred vendors of the owner and acquaintances of the owner. Preferably, the contextual assistant also employs information pertaining to the location of vendors, the price range of the vendors' merchandise, and overall past satisfaction with the vendors to recommend a contextual resolution for the task. Preferably, the personalization engine is operative to retrieve the personal information from social networks of which the owner is a member.

Preferably, the task-resolution functionality also includes at least one of a bidding platform operative to facilitate bidding by service providers on providing services for resolving the task, a 3^{rd} party application module operative to execute 3^{rd} party applications operable for resolving the task and a 3^{rd} party service warehouse including information pertaining to 3^{rd} party services which the system may employ to resolve the task. Preferably, the system resides on a host server which is accessible via the internet.

In accordance with a preferred embodiment of the present invention the automatic task management and resolution system also includes a task generator which is operative to automatically generate potential tasks for an individual. Preferably, the potential tasks pertain to the purchase of products advertised on the internet. Additionally or alternatively, the potential tasks are identical to tasks which were created by users other than the individual.

In accordance with a preferred embodiment of the present invention the automatic task management and resolution system also includes an application programming interface operative to facilitate programming interfacing with the system. Preferably, the application programming interface is also operative to receive email messages, to employ the semantic task analysis functionality to analyze the content of the messages and to provide a semantic analysis of potential task related elements of the messages to the task-resolution functionality. Preferably, the system is also operative to track actual resolution of the task.

Preferably, the automatic task management and resolution system also includes task element linking functionality operative to employ the semantic analysis to provide at least one actionable link for at least one element of the task. Preferably, the at least one actionable link is a link to a web page. Additionally or alternatively, the at least one actionable link is a link to an application.

Preferably, the contextual assistant is operative to provide optional actions which are contextually related to the task to an owner of the task. Preferably, the optional actions include at least one of online searching for a product, online searching for a service, online searching for a location of a product provider, online searching for a location of a service provider and requesting directions to any of the locations.

In accordance with a preferred embodiment of the present invention the task collaboration platform is also operative to employ the semantic analysis to provide a recommendation to collaborate between at least two individuals to resolve the task. Preferably, the task collaboration platform is also operative to prompt an owner of the task to accept the recommendation. Additionally or alternatively, the task collaboration platform is also operative to execute the recommendation.

Preferably, the set of subtasks is identical to a corresponding set of subtasks which were created in the past to resolve a task identical to the task. Additionally or alternatively, the subtasking engine is operative to employ a crowdsourcing mechanism to provide the set of subtasks.

Preferably, the bidding platform is also operative to employ the semantic analysis to recommend resolving the task by hiring at least one of the service providers.

There is also provided in accordance with another preferred embodiment of the present invention an automatic task management and resolution system including semantic task analysis functionality operative to provide a semantic analysis of at least part of a textual description of a task and task element linking functionality operative to employ the semantic analysis to provide at least one actionable link for at least one element of the task. Preferably, the at least one actionable link is a link to a web page. Additionally or alternatively, the at least one actionable link is a link to an application.

There is further provided in accordance with yet another preferred embodiment of the present invention an automatic task management and resolution system including semantic task analysis functionality operative to provide a semantic analysis of at least part of a textual description of a task and a contextual assistant operative to employ the semantic analysis to recommend at least one contextual resolution for the task, the contextual resolution being contextually related to the task. Preferably, the contextual assistant is operative to provide optional actions which are contextually related to the task to an owner of the task. Preferably, the optional actions include at least one of online searching for a product, online searching for a service, online searching for a location of a product provider, online searching for a location of a service provider and requesting directions to any of the locations.

There is yet further provided in accordance with still another preferred embodiment of the present invention an automatic task management and resolution system including semantic task analysis functionality operative to provide a semantic analysis of at least part of a textual description of a task having an owner and a personalization engine operative to employ the semantic analysis and personal information pertaining to the owner of the task to recommend at least one personalized resolution for the task.

There is also provided in accordance with another preferred embodiment of the present invention an automatic task management and resolution system including semantic task analysis functionality operative to provide a semantic analysis of at least part of a textual description of a task and a task collaboration platform operative to employ the semantic analysis to recommend collaborating between at least two individuals to resolve the task. Preferably, the task collaboration platform is also operative to employ the semantic analysis to provide a recommendation to collaborate between at least two individuals to resolve the task. Preferably, the task collaboration platform is also operative to prompt an owner of the task to accept the recommendation. Preferably, the task collaboration platform is also operative to execute the recommendation.

There is further provided in accordance with yet another preferred embodiment of the present invention an automatic task management and resolution system including semantic task analysis functionality operative to provide a semantic analysis of at least part of a textual description of a task having an owner and a task delegation engine operative to employ the semantic analysis to delegate resolving of the task to an individual other than the owner.

There is yet further provided in accordance with still another preferred embodiment of the present invention an automatic task management and resolution system including semantic task analysis functionality operative to provide a semantic analysis of at least part of a textual description of a task and a subtasking engine operative to employ the semantic analysis to break down the task into a set of subtasks and to employ the task resolution matching functionality to recommend a resolution for each of the subtasks. Preferably, the set of subtasks is identical to a corresponding set of subtasks which were created in the past to resolve a task identical to the task. Additionally or alternatively, the subtasking engine is operative to employ a crowdsourcing mechanism to provide the set of subtasks.

There is yet further provided in accordance with still another preferred embodiment of the present invention an automatic task management and resolution system including semantic task analysis functionality operative to provide a semantic analysis of at least part of a textual description of a task and a bidding platform operative to facilitate bidding by service providers on providing services for resolving the task. Preferably, the bidding platform is also operative to employ the semantic analysis to recommend resolving the task by hiring at least one of the service providers.

There is yet further provided in accordance with still another preferred embodiment of the present invention an automatic task management and resolution system including semantic task analysis functionality operative to provide a semantic analysis of at least part of a textual description of a task and auto-complete functionality operative to employ the semantic analysis to preemptively suggest at least one complementary text to complete the at least part of a textual description of a task.

Preferably, the at least one complementary text includes a task predicate with whom an owner of the task has interacted in the past. Additionally or alternatively, the at least one complementary text includes a task predicate with whom an owner of the task is acquainted. Preferably, the auto-complete functionality retrieves the predicate from at least one of the owner's phone contacts, the owner's social network contacts and public contact directories. Preferably, the at least one complementary text includes at least a refining term which refines the textual description of the task. Preferably, the auto-complete functionality is also operative to prompt an owner of the task to select one of at least one complementary text to complete the at least part of a textual description of a task.

There is yet further provided in accordance with still another preferred embodiment of the present invention an automatic task management and resolution system including semantic task analysis functionality operative to provide a semantic analysis of at least part of a textual description of a task and auto-complete functionality operative to utilize task descriptions stored in the database to preemptively suggest at least one complementary text to complete the at least part of a textual description of a task.

Preferably, the at least one complementary text includes a task predicate with whom an owner of the task has interacted in the past. Additionally or alternatively, the at least one complementary text includes a task predicate with whom an owner of the task is acquainted. Preferably, the auto-complete functionality retrieves the predicate from at least one of the owner's phone contacts, the owner's social network contacts and public contact directories. Preferably, the at least one complementary text includes at least a refining term which refines the textual description of the task. Preferably, the auto-complete functionality is also operative to prompt an owner of the task to select one of at least one complementary text to complete the at least part of a textual description of a task.

There is yet further provided in accordance with still another preferred embodiment of the present invention an automatic task management and resolution system including semantic task analysis functionality operative to provide a semantic analysis of at least part of a textual description of a task and iterative auto-complete functionality operative to employ the semantic analysis to iteratively suggest at least one complementary text to complete the at least part of a textual description of a task. Preferably, each iteration of the iterative auto-complete functionality suggests at least one complementary text includes at least a refining term which further refines the textual description of the task.

There is yet further provided in accordance with still another preferred embodiment of the present invention an automatic task management and resolution method including providing a semantic analysis of at least part of a textual description of a task and employing the semantic analysis to recommend at least one resolution for the task.

### BRIEF DESCRIPTION OF THE DRAWINGS

The present invention will be understood and appreciated more fully from the following detailed description, taken in conjunction with the drawings in which:

FIGS. 1A, 1B and 1C are simplified pictorial illustrations of an example of the operation of an automatic task management system constructed and operative in accordance with a preferred embodiment of the present invention;

FIGS. 2A and 2B are simplified pictorial illustrations of another example of an automatic task management system constructed and operative in accordance with another preferred embodiment of the present invention;

FIG. 3 is a simplified pictorial illustration of an example of an automatic task management system constructed and operative in accordance with yet another preferred embodiment of the present invention;

FIGS. 4A and 4B are simplified pictorial illustrations of an example of an automatic task management system constructed and operative in accordance with a further preferred embodiment of the present invention;

FIG. 5 is a simplified pictorial illustration of an example of an automatic task management system constructed and operative in accordance with yet a further preferred embodiment of the present invention;

FIG. 6 is a simplified pictorial illustration of an example of an automatic task management system constructed and operative in accordance with yet a further preferred embodiment of the present invention;

FIG. 7 is a simplified pictorial illustration of an example of an automatic task management system constructed and operative in accordance with yet a further preferred embodiment of the present invention;

FIG. 8 is a simplified pictorial illustration of an example of an automatic task management system constructed and operative in accordance with yet a further preferred embodiment of the present invention; and

FIGS. 9A, 9B, 9C and 9D are simplified pictorial illustrations of examples of auto-completion functionality which is part of the system of FIGS. 1A-8.

### DETAILED DESCRIPTION OF PREFERRED EMBODIMENTS

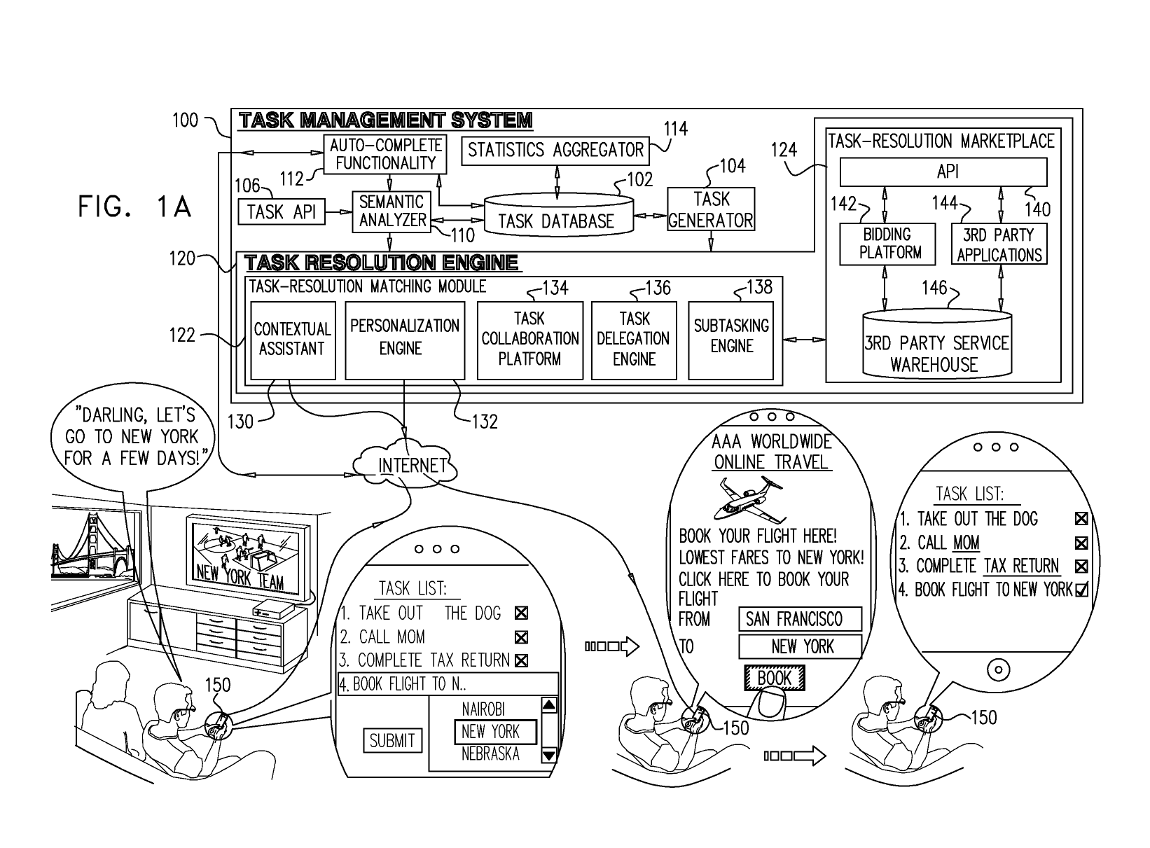

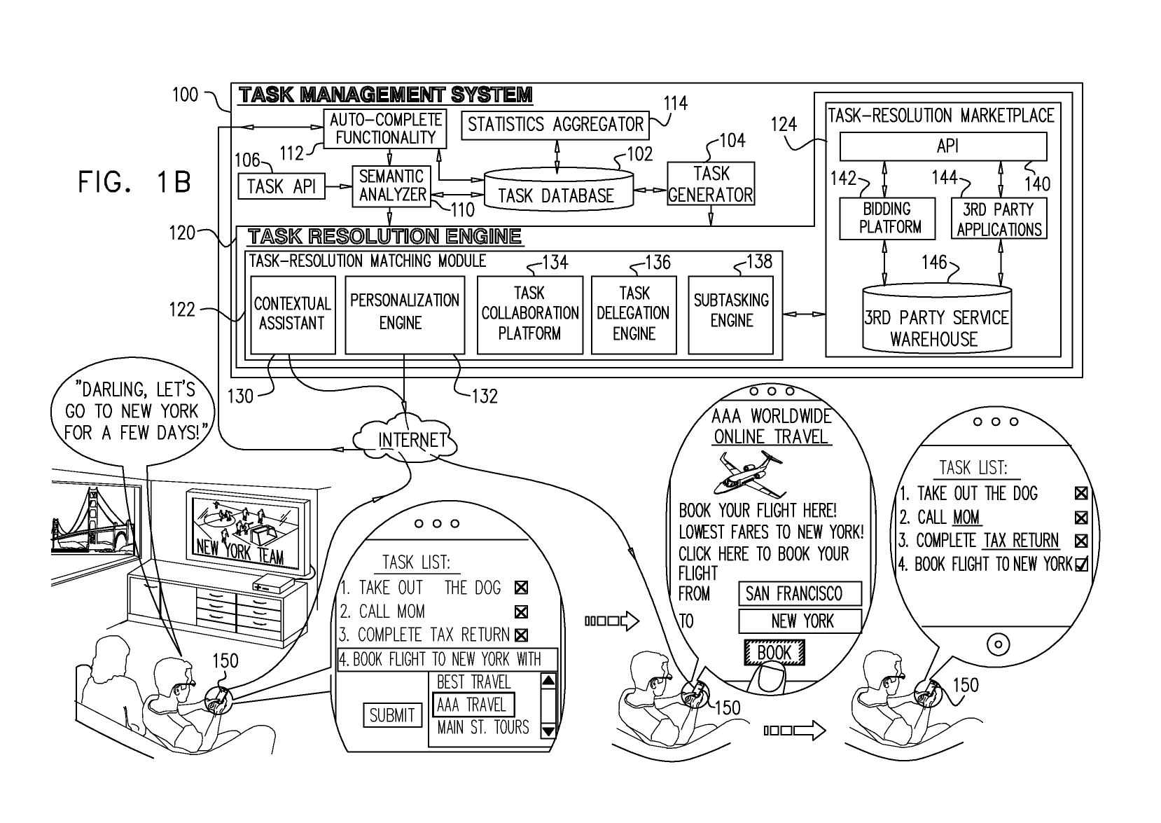

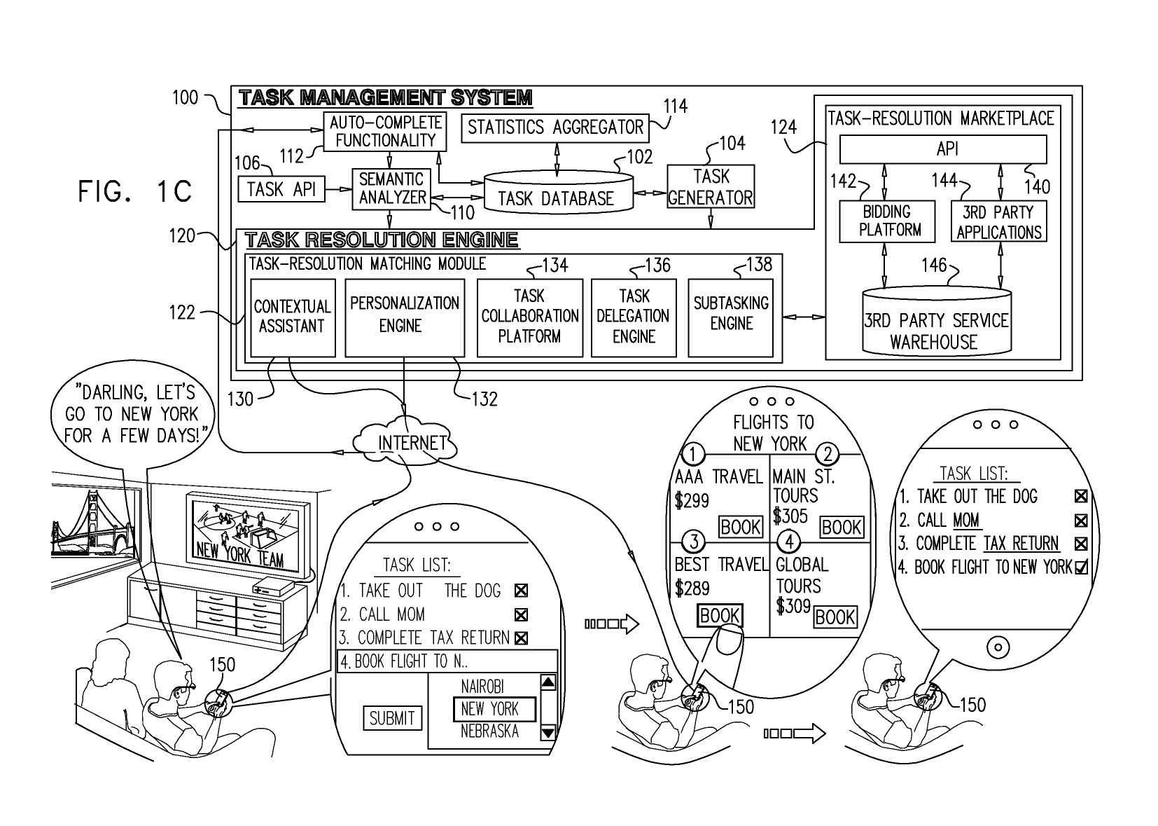

Reference is now made to FIGS. 1A, 1B and 1C, which are simplified pictorial illustrations of an example of the operation of an automatic task management and resolution system constructed and operative in accordance with a preferred embodiment of the present invention. The automatic task management and resolution system 100 of FIGS. 1A-1C preferably resides on a host server connected to the internet and comprises a task database 102 for storing task descriptions and associated task metadata. Tasks are preferably added to task database 102 via one of a task generator 104 which is operative to generate potential tasks, and a task API 106 which facilitates programmatic interfacing with system 100 by user devices connected to the internet.

It is appreciated that alternatively, system 100 may be integrated into any suitable pre-existing commercially available task management systems.

Semantic task analysis functionality 110 is preferably operative to provide a semantic analysis of at least part of a textual description of a task. Auto-complete functionality 112 is preferably operative to employ the semantic analysis and\or tasks stored in database 102 to preemptively suggest complementary text to complete the textual description of the task. A statistics aggregator 114 is also provided for aggregating task statistics.

A task resolution engine 120 is operative to automatically provide users of system 100 with recommended resolutions for their tasks. Task resolution engine 120 preferably includes a task-resolution matching module 122 and a task-resolution marketplace 124.

Task-resolution matching module 122 is operative to recommend resolutions for tasks entered into system 100. Preferably, task-resolution matching module 122 includes at least one of:

a contextual assistant 130 operative to recommend contextual resolutions for tasks, the contextual resolution of each task being contextually related to the task;

a personalization engine 132 operative to employ personal information pertaining to the owner of a task to recommend a personalized resolution for the task;

a task collaboration platform 134 operative to recommend collaborating between at least two individuals to resolve a task;

a task delegation engine 136 operative to delegate resolution of a task to an individual other than the owner of the task; and

a subtasking engine 138 operative to break down a task into at least two subtasks and to employ task-resolution matching module 122 to recommend a resolution for each of the subtasks.

Task-resolution marketplace 124 preferably includes a marketplace API 140 which facilitates external programmatic interfacing with task-resolution marketplace 124, a bidding platform 142 which facilitates bidding by service providers on providing services for resolving tasks, and a 3^{rd} party application module 144 which hosts 3^{rd} party applications for resolving tasks. Task-resolution marketplace 124 also preferably includes a 3^{rd} party service warehouse 146 which comprises information pertaining to 3^{rd} party services which system 100 may employ to resolve tasks.

As shown in FIG. 1A, a user of system 100 who is a resident of San Francisco utilizes a mobile device 150 to access system 100 to add a new task to his task list. As also shown in FIG. 1A, responsive to the user entering a partial description of the new task into device 150, auto-complete functionality 112 matches the partial description of the new task to a list of at least one task stored in task database 102 and prompts the user to select one of the tasks on the list. It is appreciated that tasks stored in task database 102 may be tasks previously entered by the user or other users, or tasks previously generated by task generator 104. Tasks generated by task generator 104 may be based on information imported from systems external to system 100. For example, task generator 104 may import a list of products offered for sale on a web site and generate a list of tasks pertaining to the purchase of the products. Task generator 104 may also generate new tasks based on tasks previously entered by the user or by other users.

In the example of FIG. 1A, the user enters a partial task description which pertains to purchasing an airline ticket. Auto-complete functionality 112, utilizing task database 102, ascertains that the partial task description pertains to purchasing an airline ticket to a destination that begins with the letter ‘N’, and prompts the user to complete the description of the task by selecting one of a multiplicity of suitable destinations. The user then completes the description of the task by choosing the destination of New York from the provided list of destinations and submits the new task into his task list.

Preferably, upon submitting the new task, system 100 proceeds to employ semantic task analysis functionality 110 to provide a semantic analysis of the task to task resolution engine 120 to initiate resolution of the task. Alternatively, the user may choose to defer resolving the new task to a later time.

Resolution engine 120 preferably provides the semantic analysis to task-resolution matching module 122. Task-resolution matching module 122 employs contextual assistant 130 which, using the semantic analysis, ascertains that the task pertains to purchasing an airline ticket to New York. Additionally, task-resolution matching module 122 employs personalization engine 132 to access personal information of the user to ascertain, for example, that the user's current location is San Francisco, and to retrieve a list of airline ticker vendors preferred by the user. It is appreciated that personalization engine 132 may access personal information of the user which is stored in system 100 or, for example, by interfacing with social networks of which the user is a member.

Using the information provided by contextual assistant 130 and personalization engine 132, task-resolution matching module 122 recommends purchasing an airline ticket from San Francisco to New York from a particular preferred vendor of the user. Alternatively, task-resolution matching module 122 may recommend vendors based on, for example, the location of the vendors, the price range of the vendors' merchandise, and overall past satisfaction with the vendors.

Responsive to the user choosing to purchase the airline ticket from the recommended vendor, system 100 updates the task as being completed on device 150.

It is a particular feature of the present invention that system 100 is operative to generate an internet link corresponding to elements of a task. For example, as shown in FIG. 1A, the words ‘tax return’ in the user's task list appear underlined and thereby comprise a web link which preferably links to an internet resource relevant to filing tax returns. Alternatively, the underlined term may comprise a link to any suitable process or application provided by system 100. It is appreciated that any particular task may include multiple linked terms.

Turning now to the example of FIG. 1B, it is shown that the user enters a partial task description which pertains to purchasing an airline ticket. Auto-complete functionality 112, utilizing task database 102, ascertains that the partial task description pertains to purchasing an airline ticket to New York from a vendor and prompts the user to complete the description of the task by selecting one of a multiplicity of possible vendors. The user then completes the description of the task by choosing a vendor from the provided list of possible vendors and submits the new task to his task list.

Preferably, upon submitting the new task, system 100 proceeds to employ semantic task analysis functionality 110 to provide a semantic analysis of the task to resolution engine 120 to initiate resolution of the task. Alternatively, the user may choose to defer resolving the new task to a later time.

Resolution engine 120 preferably provides the semantic analysis to task-resolution matching module 122. Task-resolution matching module 122 employs contextual assistant 130 which, using the semantic analysis, ascertains that the task pertains to purchasing an airline ticket to New York from the chosen vendor. Additionally, task-resolution matching module 122 employs personalization engine 132 to access personal information of the user to ascertain, for example, that the user's current location is San Francisco. Using the information provided by contextual assistant 130 and personalization engine 132, task-resolution matching module 122 recommends purchasing an airline ticket from San Francisco to New York from the vendor chosen by the user.

Responsive to the user choosing to purchase the airline ticket from the chosen vendor, system 100 updates the task as being completed on device 150.

Turning now to the example of FIG. 1C, it is shown that the user enters a partial task description which pertains to purchasing an airline ticket. Auto-complete functionality 112, utilizing task database 102, ascertains that the partial task description pertains to purchasing an airline ticket to a destination that begins with the letter ‘N’, and prompts the user to complete the description of the task by selecting one of a multiplicity of possible destinations. The user then completes the description of the task by choosing the destination of New York from the provided list of destinations and submits the new task into his task list.

Preferably, upon submitting the new task, system 100 proceeds to employ semantic task analysis functionality 110 to provide a semantic analysis of the task to resolution engine 120 to initiate resolution of the task. Alternatively, the user may choose to defer resolving the new task to a later time.

Resolution engine 120 preferably provides the semantic analysis to task-resolution matching module 122. Task-resolution matching module 122 employs contextual assistant 130 which, using the semantic analysis, ascertains that the task pertains to purchasing an airline ticket to New York. Additionally, task-resolution matching module 122 employs personalization engine 132 is provided access to personal information of the user, such as vendors which were preferred by the user in the past. Using the information provided by contextual assistant 130 and personalization engine 132, task-resolution matching module 122 provides the user with a list of preferred vendors of airline tickets to New York, along with their respective fees. Alternatively, task-resolution matching module 122 may recommend vendors based on, for example, the location of the vendors, the price range of the vendors' merchandise, and overall past satisfaction with the vendors.

Responsive to the user choosing to purchase the airline ticket from one of the recommended vendors, system 100 updates the task as being completed on device 150.

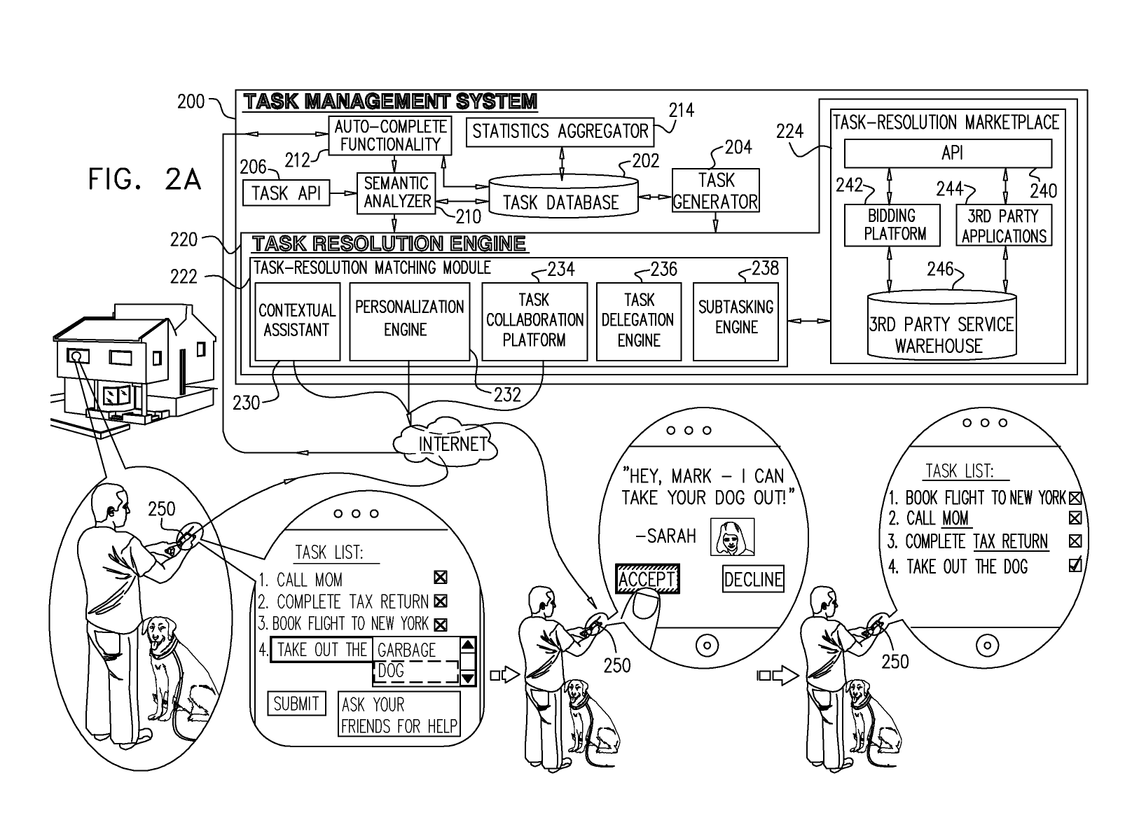

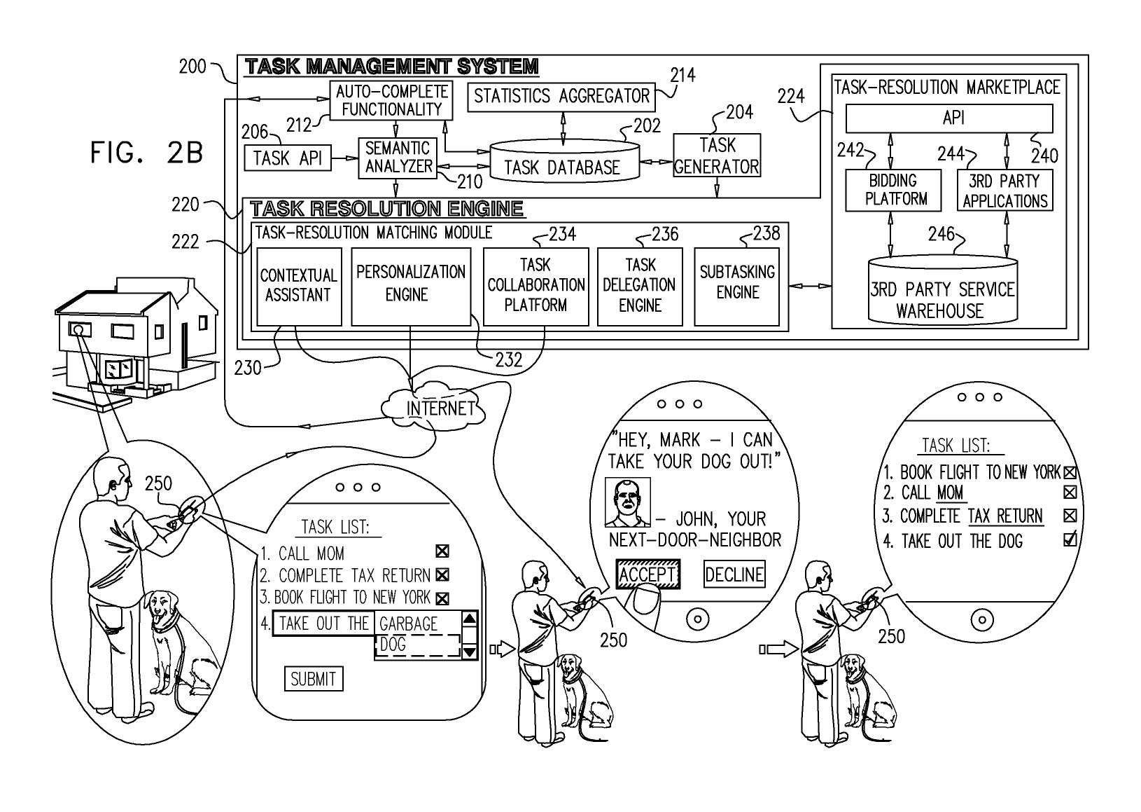

Reference is now made to FIGS. 2A and 2B, which are simplified pictorial illustrations of another example of an automatic task management system constructed and operative in accordance with another preferred embodiment of the present invention. The automatic task management and resolution system 200 of FIGS. 2A & 2B preferably resides on a host server connected to the internet and comprises a task database 202 for storing task descriptions and associated task metadata. Tasks are preferably added to task database 202 via one of a task generator 204 which is operative to generate potential tasks, and a task API 206 which facilitates programmatic interfacing with system 200 by user devices connected to the internet.

It is appreciated that alternatively, system 200 may be integrated into any suitable pre-existing commercially available task management systems.

Semantic task analysis functionality 210 is preferably operative to provide a semantic analysis of at least part of a textual description of a task. Auto-complete functionality 212 is preferably operative to employ the semantic analysis and\or tasks stored in database 202 to preemptively suggest complementary text to complete the textual description of the task. A statistics aggregator 214 is also provided for aggregating task statistics.

A task resolution engine 220 is operative to automatically provide users of system 200 with recommended resolutions for their tasks. Task resolution engine 220 preferably includes a task-resolution matching module 222 and a task-resolution marketplace 224.

Task-resolution matching module 222 is operative to recommend resolutions for tasks entered into system 200. Preferably, task-resolution matching module 222 includes at least one of:

a contextual assistant 230 operative to recommend contextual resolutions for tasks, the contextual resolution of each task being contextually related to the task;

a personalization engine 232 operative to employ personal information pertaining to the owner of a task to recommend a personalized resolution for the task;

a task collaboration platform 234 operative to recommend collaborating between at least two individuals to resolve a task;

a task delegation engine 236 operative to delegate resolution of a task to an individual other than the owner of the task; and

a subtasking engine 238 operative to break down a task into at least two subtasks and to employ task-resolution matching module 222 to recommend a resolution for each of the subtasks.

Task-resolution marketplace 224 preferably includes a marketplace API 240 which facilitates external programmatic interfacing with task-resolution marketplace 224, a bidding platform 242 which facilitates bidding by service providers on providing services for resolving tasks, and a 3^{rd} party application module 244 which hosts 3^{rd} party applications for resolving tasks. Task-resolution marketplace 224 also preferably includes a 3^{rd} party service warehouse 246 which comprises information pertaining to 3^{rd} party services which system 200 may employ to resolve tasks.

As shown in FIG. 2A, a user of system 200 utilizes a mobile device 250 to access system 200 to add a new task to his task list. As also shown in FIG. 2A, responsive to the user entering a partial description of the new task into device 250, auto-complete functionality 212 matches the partial description of the new task to a list of at least one task stored in task database 202 and prompts the user to select one of the tasks on the list. It is appreciated that tasks stored in task database 202 may be tasks previously entered by the user or other users, or tasks previously generated by task generator 204. Tasks generated by task generator 204 may be based on information imported from systems external to system 200. For example, task generator 204 may import a list of products offered for sale on a web site and generate a list of tasks pertaining to the purchase of the products. Task generator 204 may also generate new tasks based on tasks previously entered by the user or by other users.

In the example of FIG. 2A, the user enters a partial task description which pertains to a common household chore, such as taking a pet dog out for a walk. Auto-complete functionality 212, utilizing task database 202, ascertains that the partial task description pertains to something that needs to be taken out of the house and prompts the user to complete the description of the task by selecting one of a multiplicity of possible items. The user completes the description of the task by selecting the dog as that which needs to be taken out of the house, and submits the new task to his task list.

Preferably, upon submitting the new task, system 200 proceeds to employ semantic task analysis functionality 210 to provide a semantic analysis of the task to resolution engine 220 to initiate resolution of the task. Alternatively, the user may choose to defer resolving the new task to a later time.

Resolution engine 220 preferably provides the semantic analysis to task-resolution matching module 222. Task-resolution matching module 222 employs contextual assistant 230 which, using the semantic analysis, ascertains that the task pertains to taking out the dog. Additionally, task-resolution matching module 222 employs personalization engine 232 to access personal information of the user, such as a list of the user's friends. In the example of FIG. 2A, personalization engine 232 ascertains that Sarah is a friend of the user. It is appreciated that personalization engine 232 may access personal information of the user which is stored in system 200 or, for example, by interfacing with social networks of which the user is a member.

It is a particular feature of this embodiment of the present invention that task collaboration platform 234 is operative to employ the information provided by contextual assistant 230 and personalization engine 232 to recommend collaborating between the user and additional individuals in resolving a task. For example, task-resolution matching module 222 may notify Sarah, an acquaintance of the user, of the user's task of taking out the dog, and prompt her to propose to collaborate in resolving the task. It is appreciated that task collaboration platform 234 is also preferably operative to preserve information pertaining to collaborative tasks, such as user actions, inter-user communication and related files.

In the example of FIG. 2A, Sarah proposes to collaborate with the user and to assist in resolving the task of taking out the dog. Upon accepting Sarah's offer of collaboration, system 200 updates the task as being completed on device 250.

Alternatively, as shown in FIG. 2B, task-resolution matching module 222 may notify John, a neighbor of the user, of the user's task of taking out the dog, and prompt him to propose to collaborate in resolving the task.

In the example of FIG. 2B, John proposes to collaborate with the user and to assist in resolving the task of taking out the dog. Upon accepting John's offer of collaboration, system 200 updates the task as being completed on device 250.

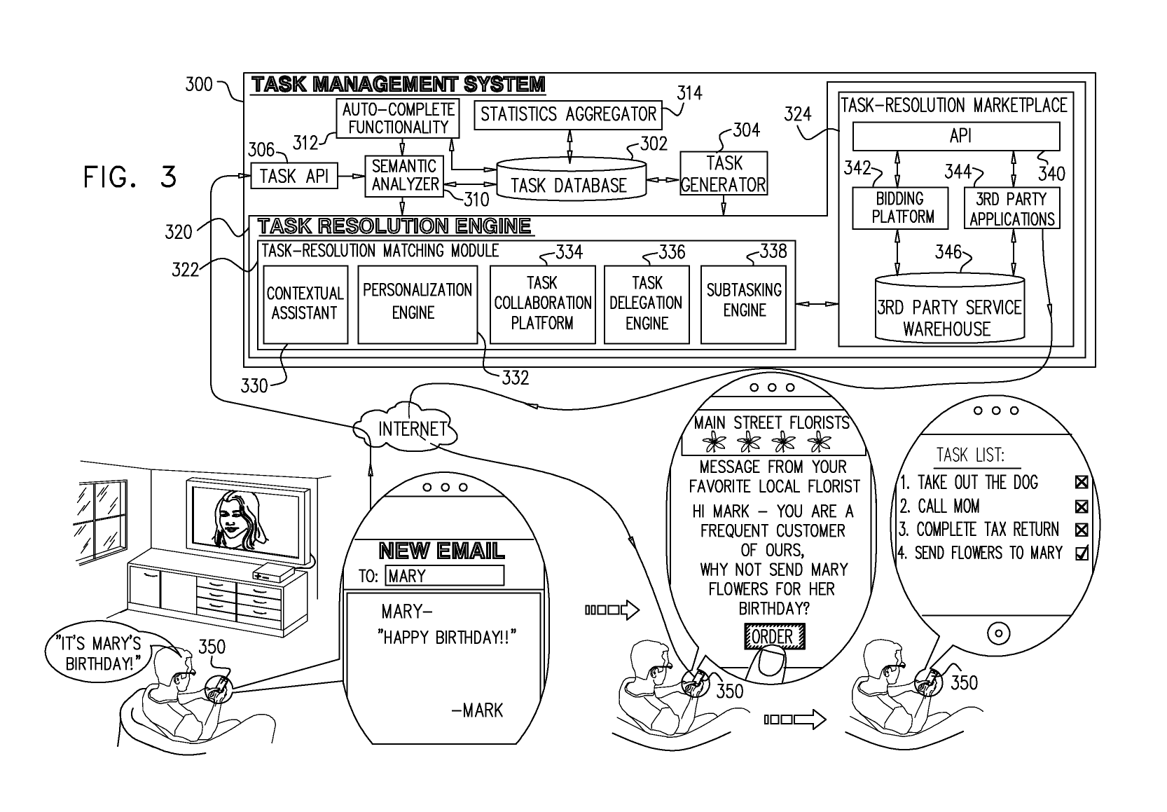

Reference is now made to FIG. 3, which is a simplified pictorial illustration of an example of an automatic task management system constructed and operative in accordance with yet another preferred embodiment of the present invention. The automatic task management and resolution system 300 of FIG. 3 preferably resides on a host server connected to the internet and comprises a task database 302 for storing task descriptions and associated task metadata. Tasks are preferably added to task database 302 via one of a task generator 304 which is operative to generate potential tasks, and a task API 306 which facilitates programmatic interfacing with system 300 by user devices connected to the internet.

It is appreciated that alternatively, system 300 may be integrated into any suitable pre-existing commercially available task management systems.

Semantic task analysis functionality 310 is preferably operative to provide a semantic analysis of at least part of a textual description of a task. Auto-complete functionality 312 is preferably operative to employ the semantic analysis and\or tasks stored in database 302 to preemptively suggest complementary text to complete the textual description of the task. A statistics aggregator 314 is also provided for aggregating task statistics.

A task resolution engine 320 is operative to automatically provide users of system 300 with recommended resolutions for their tasks. Task resolution engine 320 preferably includes a task-resolution matching module 322 and a task-resolution marketplace 324.

Task-resolution matching module 322 is operative to recommend resolutions for tasks entered into system 300. Preferably, task-resolution matching module 322 includes at least one of:

a contextual assistant 330 operative to recommend contextual resolutions for tasks, the contextual resolution of each task being contextually related to the task;

a personalization engine 332 operative to employ personal information pertaining to the owner of a task to recommend a personalized resolution for the task;

a task collaboration platform 334 operative to recommend collaborating between at least two individuals to resolve a task;

a task delegation engine 336 operative to delegate resolution of a task to an individual other than the owner of the task; and

a subtasking engine 338 operative to break down a task into at least two subtasks and to employ task-resolution matching module 322 to recommend a resolution for each of the subtasks.

Task-resolution marketplace 324 preferably includes a marketplace API 340 which facilitates external programmatic interfacing with task-resolution marketplace 324, a bidding platform 342 which facilitates bidding by service providers on providing services for resolving tasks, and a 3^{rd} party application module 344 which hosts 3^{rd} party applications for resolving tasks. Task-resolution marketplace 324 also preferably includes a 3^{rd} party service warehouse 346 which comprises information pertaining to 3^{rd} party services which system 300 may employ to resolve tasks.

In the example of FIG. 3, Mark, a user of a mobile device 350 utilizes device 350 to send an email message 352 to Mary, an acquaintance of his, wishing Mary a happy birthday. As shown in FIG. 3, task API 306 is operative to intercept email message 352 from device 350 and to forward content thereof to semantic task analysis functionality 310. Semantic task analysis functionality 310 preferably analyzes the content of message 352 and provides a semantic analysis of message 352 to resolution engine 320.

Resolution engine 320 preferably provides the semantic analysis to task-resolution matching module 322. Task-resolution matching module 322 employs contextual assistant 330 which, using the semantic analysis, ascertain that message 352 pertains to birthday wishes and therefore recommends a task resolution which comprises sending flowers to Mary.

Additionally, task-resolution matching module 322 employs personalization engine 332 to access Mark's personal information, such as his location and his preferred flower store. It is appreciated that personalization engine 332 may access personal information of the user which is stored in system 300 or, for example, by interfacing with social networks of which the user is a member.

Utilizing Mark's personal information, task-resolution matching module 322 employs 3^{rd} party application module 344 of task-resolution marketplace 324 via marketplace API 340 to send a message to Mark from his preferred flower store, offering their services to send Mary flowers. Alternatively, 3^{rd} party application module 344 may retrieve information stored in 3^{rd} party service warehouse 346 pertaining to 3^{rd} party flower delivery services and to recommend these services to Mark.

Responsive to Mark choosing to order flowers from the recommended vendor, system 300 updates the task as being completed on device 350.

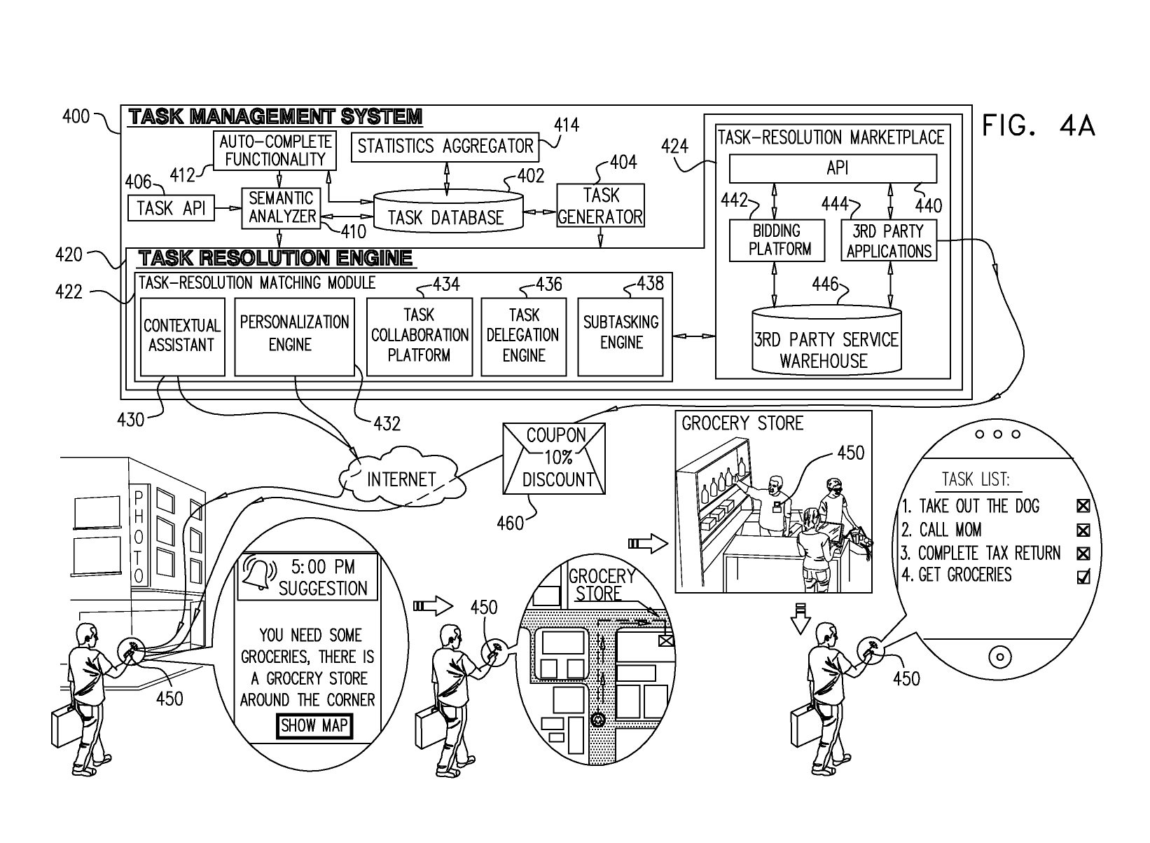

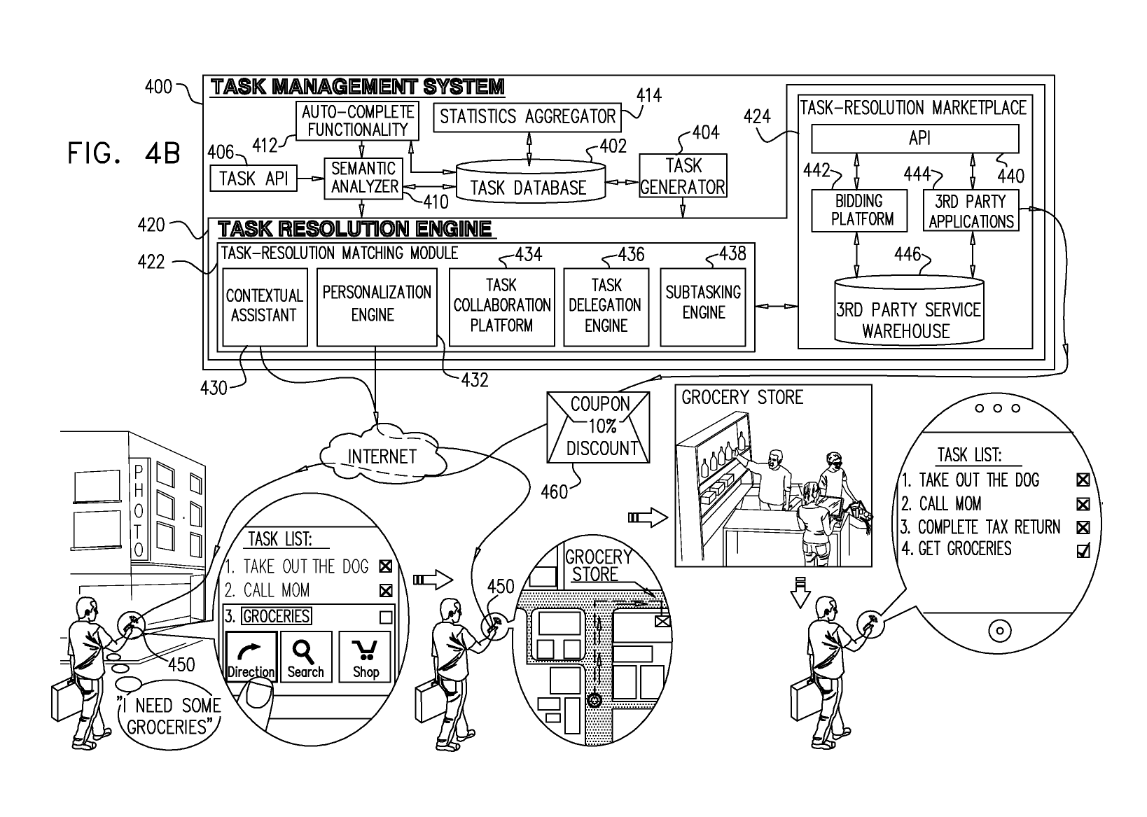

Reference is now made to FIGS. 4A and 4B, which are simplified pictorial illustrations of an example of an automatic task management system constructed and operative in accordance with a further preferred embodiment of the present invention. The automatic task management and resolution system 400 of FIGS. 4A & 4B preferably resides on a host server connected to the internet and comprises a task database 402 for storing task descriptions and associated task metadata. Tasks are preferably added to task database 402 via one of a task generator 404 which is operative to generate potential tasks, and a task API 406 which facilitates programmatic interfacing with system 400 by user devices connected to the internet.

It is appreciated that alternatively, system 400 may be integrated into any suitable pre-existing commercially available task management systems.

Semantic task analysis functionality 410 is preferably operative to provide a semantic analysis of at least part of a textual description of a task. Auto-complete functionality 412 is preferably operative to employ the semantic analysis and\or tasks stored in database 402 to preemptively suggest complementary text to complete the textual description of the task. A statistics aggregator 414 is also provided for aggregating task statistics.

A task resolution engine 420 is operative to automatically provide users of system 400 with recommended resolutions for their tasks. Task resolution engine 420 preferably includes a task-resolution matching module 422 and a task-resolution marketplace 424.

Task-resolution matching module 422 is operative to recommend resolutions for tasks entered into system 400. Preferably, task-resolution matching module 422 includes at least one of:

a contextual assistant 430 operative to recommend contextual resolutions for tasks, the contextual resolution of each task being contextually related to the task;

a personalization engine 432 operative to employ personal information pertaining to the owner of a task to recommend a personalized resolution for the task;

a task collaboration platform 434 operative to recommend collaborating between at least two individuals to resolve a task;

a task delegation engine 436 operative to delegate resolution of a task to an individual other than the owner of the task; and

a subtasking engine 438 operative to break down a task into at least two subtasks and to employ task-resolution matching module 422 to recommend a resolution for each of the subtasks.

Task-resolution marketplace 434 preferably includes a marketplace API 440 which facilitates external programmatic interfacing with task-resolution marketplace 424, a bidding platform 442 which facilitates bidding by service providers on providing services for resolving tasks, and a 3^{rd} party application module 444 which hosts 3^{rd} party applications for resolving tasks. Task-resolution marketplace 424 also preferably includes a 3^{rd} party service warehouse 446 which comprises information pertaining to 3^{rd} party services which system 400 may employ to resolve tasks.

As shown in FIG. 4A, task generator 404 automatically generates a new task for a user of system 400, which task pertains to purchasing groceries, and employs task resolution engine 420 to recommend a resolution for the task to the user. Task resolution engine 420 preferably employs personalization engine 432 to access personal information of the user, such as for example, the user's shopping habits, an inventory of groceries stocked at the user's home, and the user's location. It is appreciated that personalization engine 432 may access personal information of the user which is stored in system 400 or, for example, by interfacing with social networks of which the user is a member.

Additionally, contextual assistant 430 preferably ascertains that the user is in the vicinity of a grocery store. Using the information provided by contextual assistant 430 and personalization engine 432, task-resolution matching module 422 recommends to the user to shop for groceries at a nearby grocery store preferably via a text message sent to the user's mobile device 450. As shown in FIG. 4A, task-resolution matching module 422 also provides the user with a map showing a route to the grocery store.

In the example of FIG. 4A, task-resolution marketplace 424 employs 3^{rd} party application module 444 to send the user a discount coupon 460 which is good for use at the grocery store.

As shown in FIG. 4A, upon completing the purchase of groceries at the grocery store, the user updates the task as being complete on device 450.

Turning now to FIG. 4B, it is shown that a user of system 400 uses mobile device 450 to enter a new task into system 400 via task API 406, which task pertains to purchasing groceries. Semantic task analysis functionality 410 preferably analyzes the task and provides a semantic analysis of the task to resolution engine 420.

Resolution engine 420 preferably provides the semantic analysis to task-resolution matching module 422. Task-resolution matching module 422 preferably employs contextual assistant 430 which, using the semantic analysis, ascertains that the task pertains to purchasing groceries. Additionally, task-resolution matching module 422 employs personalization engine 432 to access the user's personal information, such as his location and his preferred grocery store.

It is a particular feature of the present invention that contextual assistant 430 is operative to provide the user with optional actions which are contextually related to a particular task. In the example of FIG. 4B, contextual assistant 430 provides the user with several optional actions which relate to the purchase of groceries, such as requesting directions to a grocery store, searching for stores or products, and shopping online.

As shown in FIG. 4B, the user requests directions to a grocery store. Task-resolution matching module 422, using the user's personal information, such as his location and his preferred grocery store, provides the user with a map showing a route to the grocery store.

In the example of FIG. 4B, task-resolution marketplace 424 employs 3^{rd} party application module 444 to send the user a discount coupon 460 which is good for use at the grocery store.

As shown in FIG. 4B, upon completing the purchase of groceries at the grocery store, the user updates the task as being complete on device 450.

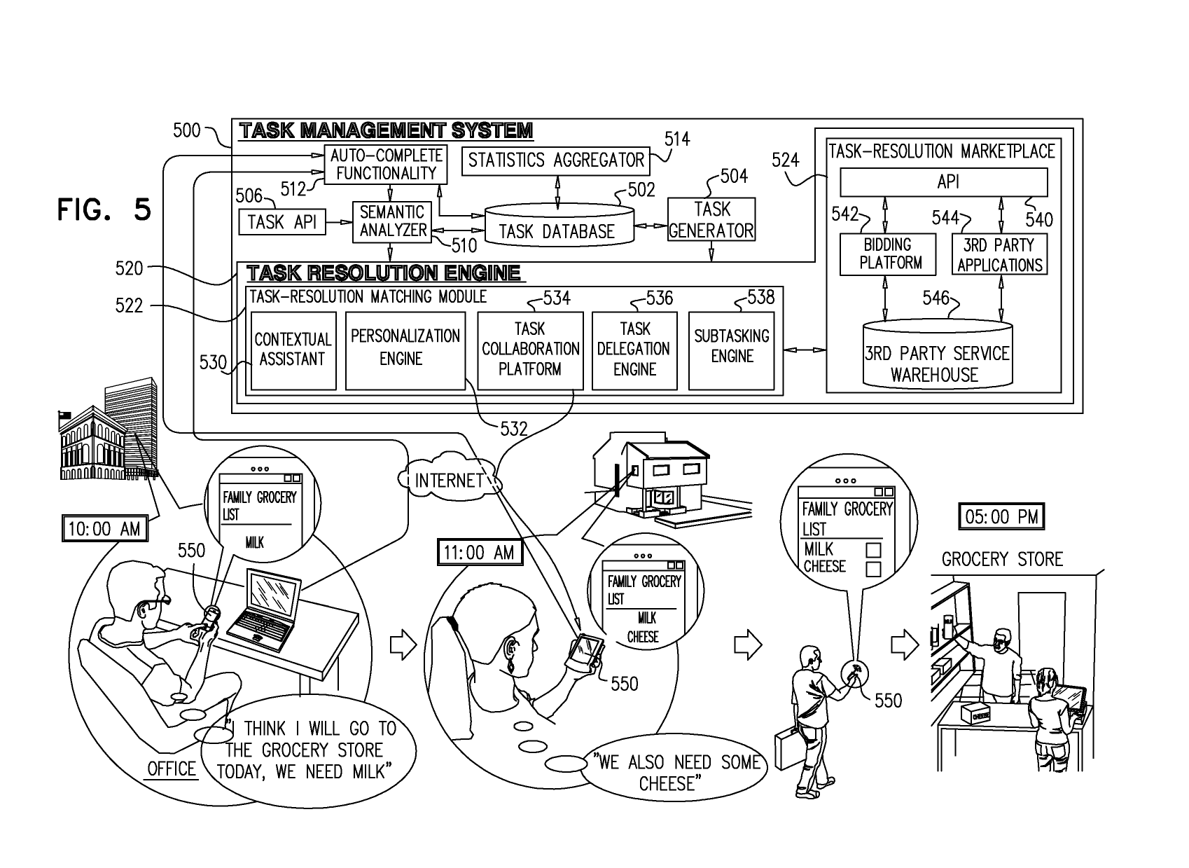

Reference is now made to FIG. 5, which is a simplified pictorial illustration of an example of an automatic task management system constructed and operative in accordance with yet a further preferred embodiment of the present invention. The automatic task management and resolution system 500 of FIG. 5 preferably resides on a host server connected to the internet and comprises a task database 502 for storing task descriptions and associated task metadata. Tasks are preferably added to task database 502 via one of a task generator 504 which is operative to generate potential tasks, and a task API 506 which facilitates programmatic interfacing with system 500 by user devices connected to the internet.

It is appreciated that alternatively, system 500 may be integrated into any suitable pre-existing commercially available task management systems.

Semantic task analysis functionality 510 is preferably operative to provide a semantic analysis of at least part of a textual description of a task. Auto-complete functionality 512 is preferably operative to employ the semantic analysis and\or tasks stored in database 502 to preemptively suggest complementary text to complete the textual description of the task. A statistics aggregator 514 is also provided for aggregating task statistics.

A task resolution engine 520 is operative to automatically provide users of system 500 with recommended resolutions for their tasks. Task resolution engine 520 preferably includes a task-resolution matching module 522 and a task-resolution marketplace 524.

Task-resolution matching module 522 is operative to recommend resolutions for tasks entered into system 500. Preferably, task-resolution matching module 522 includes at least one of:

a contextual assistant 530 operative to recommend contextual resolutions for tasks, the contextual resolution of each task being contextually related to the task;

a personalization engine 532 operative to employ personal information pertaining to the owner of a task to recommend a personalized resolution for the task;

a task collaboration platform 534 operative to recommend collaborating between at least two individuals to resolve a task;

a task delegation engine 536 operative to delegate resolution of a task to an individual other than the owner of the task; and

a subtasking engine 538 operative to break down a task into at least two subtasks and to employ task-resolution matching module 522 to recommend a resolution for each of the subtasks.

Task-resolution marketplace 524 preferably includes a marketplace API 540 which facilitates external programmatic interfacing with task-resolution marketplace 524, a bidding platform 542 which facilitates bidding by service providers on providing services for resolving tasks, and a 3^{rd} party application module 544 which hosts 3^{rd} party applications for resolving tasks. Task-resolution marketplace 524 also preferably includes a 3^{rd} party service warehouse 546 which comprises information pertaining to 3^{rd} party services which system 500 may employ to resolve tasks.

As shown in FIG. 5, a user of system 500 utilizes a mobile device 550 to access system 500 to enter a partial family grocery list into his task list. Preferably, the user is assisted in entering the task by auto-complete functionality 512 as described hereinabove with regard to the embodiments of FIGS. 1A-2B.

Preferably, upon submitting the new task, system 500 proceeds to employ semantic task analysis functionality 510 to provide a semantic analysis of the task to resolution engine 520 which in turn provides the semantic analysis to task-resolution matching module 522. Task-resolution matching module 522 preferably utilizes the semantic analysis to ascertain that task relates to the user's family and employs personalization engine 532 to access personal information of the user, such as a list of the user's family members. It is appreciated that personalization engine 532 may access personal information of the user which is stored in system 500 or, for example, by interfacing with social networks of which the user is a member.

It is a particular feature of this embodiment of the present invention that task collaboration platform 534 is operative to employ the information provided by personalization engine 532 to prompt collaboration between the user and additional individuals in resolving a task. For example, as shown in FIG. 5, task-resolution matching module 522 may notify the user's wife of the user's newly entered family grocery list, and prompt her to collaborate by adding items to the grocery list. It is appreciated that task collaboration platform 534 is also preferably operative to log any events which take place with regard to the execution of collaborative tasks, such as for example, user actions, inter-user communication and related files posted by users. It is appreciated that task collaboration platform 534 is preferably operative to suggest individuals with whom to collaborate with or to prompt the user to choose individuals with whom to collaborate with.

In the example of FIG. 5, the user's wife collaborates with the user by adding items to the grocery list. As further shown in FIG. 5, at a later time, the user arrives at the grocery store and uses device 550 to retrieve the complete grocery list from system 500. As described hereinabove regarding FIG. 4A, task-resolution marketplace 524 may employ 3^{rd} party application module 544 to send the user a discount coupon which is good for use at the grocery store.

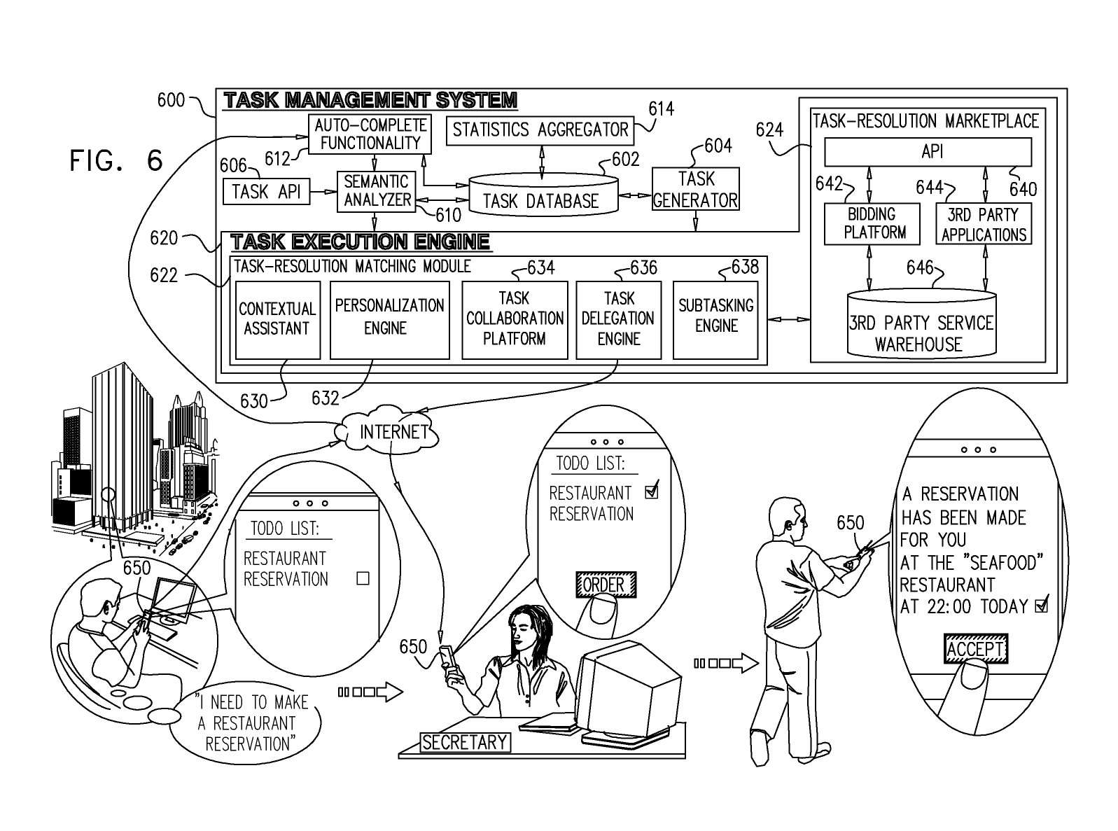

Reference is now made to FIG. 6, which is a simplified pictorial illustration of an example of an automatic task management system constructed and operative in accordance with yet a further preferred embodiment of the present invention. The automatic task management and resolution system 600 of FIG. 6 preferably resides on a host server connected to the internet and comprises a task database 602 for storing task descriptions and associated task metadata. Tasks are preferably added to task database 602 via one of a task generator 604 which is operative to generate potential tasks, and a task API 606 which facilitates programmatic interfacing with system 600 by user devices connected to the internet.

It is appreciated that alternatively, system 600 may be integrated into any suitable pre-existing commercially available task management systems.

Semantic task analysis functionality 610 is preferably operative to provide a semantic analysis of at least part of a textual description of a task. Auto-complete functionality 612 is preferably operative to employ the semantic analysis and\or tasks stored in database 602 to preemptively suggest complementary text to complete the textual description of the task. A statistics aggregator 614 is also provided for aggregating task statistics.

A task resolution engine 620 is operative to automatically provide users of system 600 with recommended resolutions for their tasks. Task resolution engine 620 preferably includes a task-resolution matching module 622 and a task-resolution marketplace 624.

Task-resolution matching module 622 is operative to recommend resolutions for tasks entered into system 600. Preferably, task-resolution matching module 622 includes at least one of:

a contextual assistant 630 operative to recommend contextual resolutions for tasks, the contextual resolution of each task being contextually related to the task;

a personalization engine 632 operative to employ personal information pertaining to the owner of a task to recommend a personalized resolution for the task;

a task collaboration platform 634 operative to recommend collaborating between at least two individuals to resolve a task;

a task delegation engine 636 operative to delegate resolution of a task to an individual other than the owner of the task; and

a subtasking engine 638 operative to break down a task into at least two subtasks and to employ task-resolution matching module 622 to recommend a resolution for each of the subtasks.

Task-resolution marketplace 624 preferably includes a marketplace API 640 which facilitates external programmatic interfacing with task-resolution marketplace 624, a bidding platform 642 which facilitates bidding by service providers on providing services for resolving tasks, and a 3^{rd} party application module 644 which hosts 3^{rd} party applications for resolving tasks. Task-resolution marketplace 624 also preferably includes a 3^{rd} party service warehouse 646 which comprises information pertaining to 3^{rd} party services which system 600 may employ to resolve tasks.

As shown in FIG. 6, a user of system 600 utilizes a mobile device 650 to access system 600 to enter a new task regarding making a restaurant reservation into his task list. Preferably, the user is assisted in entering the task by auto-complete functionality 612 as described hereinabove with regard to the embodiments of FIGS. 1A-2B.

Preferably, upon submitting the new task, system 600 proceeds to employ semantic task analysis functionality 610 to provide a semantic analysis of the task to resolution engine 620 which in turn provides the semantic analysis to task-resolution matching module 622. Task-resolution matching module 622 preferably utilizes the semantic analysis to ascertain that task pertains to restaurant reservations.

It is a particular feature of this embodiment of the present invention that task delegation engine 636 is operative to prompt delegation of the resolution of a task to an individual other than the owner of the task. For example, as shown in FIG. 6, task-task delegation engine 636 may notify the user's secretary of the user's newly entered task of making a restaurant reservation, and prompt her to make the reservation. It is appreciated that task delegation engine 636 is also preferably operative to log any events which take place with regard to the execution of delegated tasks, such as user actions, inter-user communication and related files posted by users. It is appreciated that task delegation engine 636 is preferably operative to suggest individuals to whom to delegate to or to prompt the user to choose individuals to whom to delegate to.

In the example of FIG. 6, the user's secretary resolves the task by making a restaurant reservation. As further shown in FIG. 6, at a later time, the user receives confirmation on device 650 that the restaurant reservation has been made.

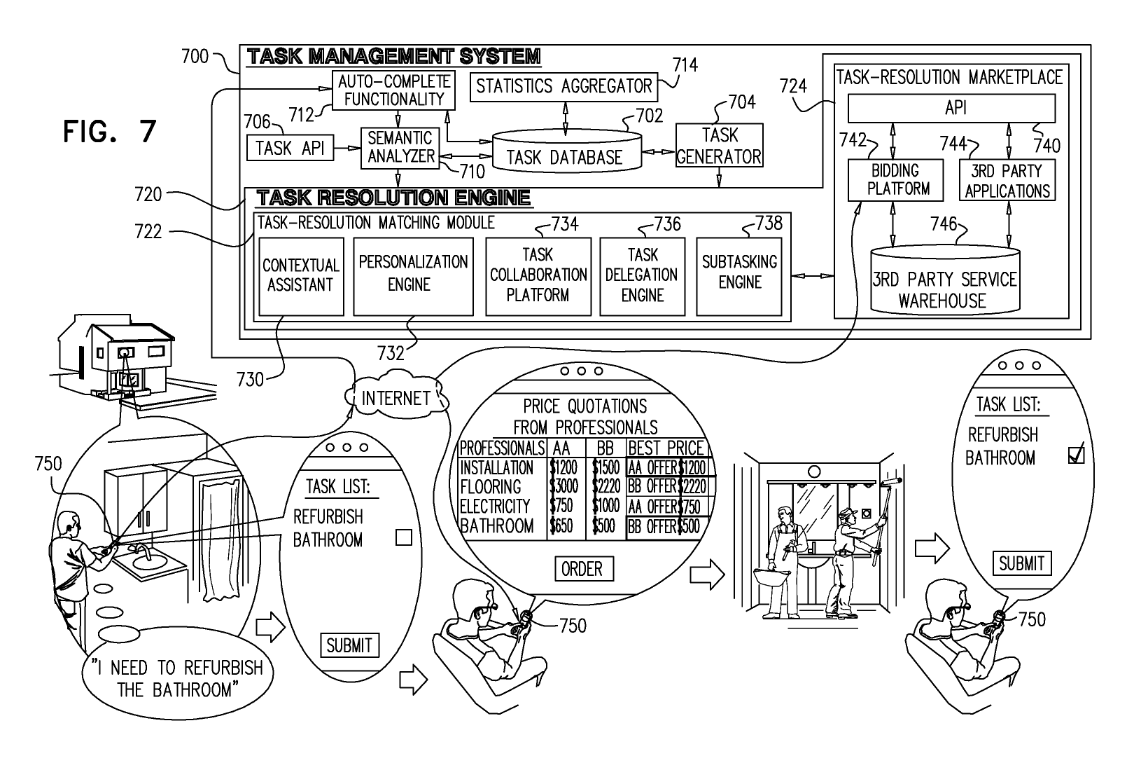

Reference is now made to FIG. 7, which is a simplified pictorial illustration of an example of an automatic task management system constructed and operative in accordance with yet a further preferred embodiment of the present invention. The automatic task management and resolution system 700 of FIG. 7 preferably resides on a host server connected to the internet and comprises a task database 702 for storing task descriptions and associated task metadata. Tasks are preferably added to task database 702 via one of a task generator 704 which is operative to generate potential tasks, and a task API 706 which facilitates programmatic interfacing with system 700 by user devices connected to the internet.

It is appreciated that alternatively, system 700 may be integrated into any suitable pre-existing commercially available task management systems.

Semantic task analysis functionality 710 is preferably operative to provide a semantic analysis of at least part of a textual description of a task. Auto-complete functionality 712 is preferably operative to employ the semantic analysis and\or tasks stored in database 702 to preemptively suggest complementary text to complete the textual description of the task. A statistics aggregator 714 is also provided for aggregating task statistics.

A task resolution engine 720 is operative to automatically provide users of system 700 with recommended resolutions for their tasks. Task resolution engine 720 preferably includes a task-resolution matching module 722 and a task-resolution marketplace 724.

Task-resolution matching module 722 is operative to recommend resolutions for tasks entered into system 700. Preferably, task-resolution matching module 722 includes at least one of:

a contextual assistant 730 operative to recommend contextual resolutions for tasks, the contextual resolution of each task being contextually related to the task;

a personalization engine 732 operative to employ personal information pertaining to the owner of a task to recommend a personalized resolution for the task;

a task collaboration platform 734 operative to recommend collaborating between at least two individuals to resolve a task;

a task delegation engine 736 operative to delegate resolution of a task to an individual other than the owner of the task; and

a subtasking engine 738 operative to break down a task into at least two subtasks and to employ task-resolution matching module 722 to recommend a resolution for each of the subtasks.

Task-resolution marketplace 724 preferably includes a marketplace API 740 which facilitates external programmatic interfacing with task-resolution marketplace 724, a bidding platform 742 which facilitates bidding by service providers on providing services for resolving tasks, and a 3^{rd} party application module 744 which hosts 3^{rd} party applications for resolving tasks. Task-resolution marketplace 724 also preferably includes a 3^{rd} party service warehouse 746 which comprises information pertaining to 3^{rd} party services which system 700 may employ to resolve tasks.

As shown in FIG. 7, a user of system 700 utilizes a mobile device 750 to access system 700 to enter a task pertaining to refurbishing a bathroom into his task list. Preferably, the user is assisted in entering the task by auto-complete functionality 712 as described hereinabove with regard to the embodiments of FIGS. 1A-2B.

Preferably, upon submitting the new task, system 700 proceeds to employ semantic task analysis functionality 710 to provide a semantic analysis of the task to resolution engine 720 which in turn provides the semantic analysis to task-resolution matching module 722. Task-resolution matching module 722 employs contextual assistant 730 which, using the semantic analysis, ascertain that message 752 pertains to bathroom refurbishment and therefore recommends a task resolution which comprises hiring one or more professional refurbishers. Therefore, task-resolution matching module 722 employs bidding platform 742 of task-resolution marketplace 724 via marketplace API 740 to facilitate bidding by professional refurbishers on various elements of the refurbishing job, and to recommend the best offer to the user.

As shown in FIG. 7, responsive to the user choosing to accept one or more of the offers recommended by bidding platform 742, the refurbishers execute the refurbishing job, and system 700 updates the task as being completed on device 750.

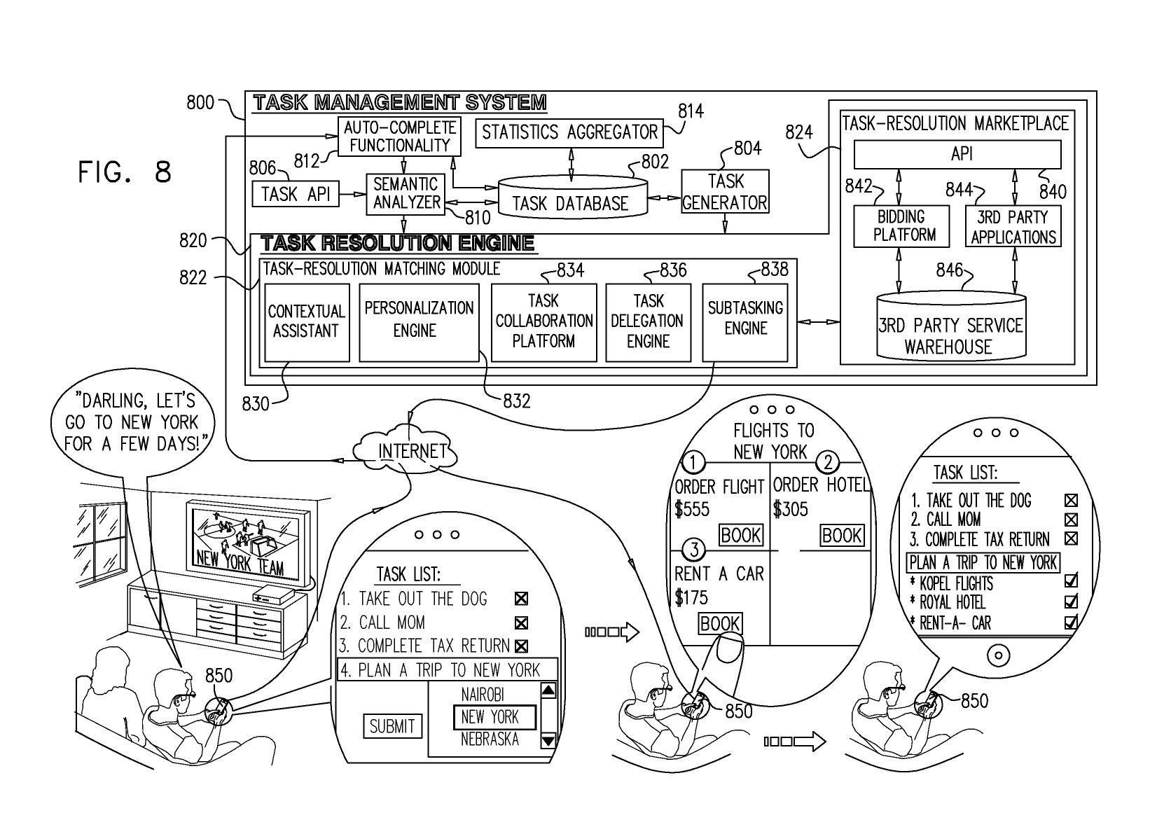

Reference is now made to FIG. 8, which is a simplified pictorial illustration of an example of an automatic task management system constructed and operative in accordance with yet a further preferred embodiment of the present invention. The automatic task management and resolution system 800 of FIG. 8 preferably resides on a host server connected to the internet and comprises a task database 802 for storing task descriptions and associated task metadata. Tasks are preferably added to task database 802 via one of a task generator 804 which is operative to generate potential tasks, and a task API 806 which facilitates programmatic interfacing with system 800 by user devices connected to the internet.

It is appreciated that alternatively, system 800 may be integrated into any suitable pre-existing commercially available task management systems.

Semantic task analysis functionality 810 is preferably operative to provide a semantic analysis of at least part of a textual description of a task. Auto-complete functionality 812 is preferably operative to employ the semantic analysis and\or tasks stored in database 802 to preemptively suggest complementary text to complete the textual description of the task. A statistics aggregator 814 is also provided for aggregating task statistics.

A task resolution engine 820 is operative to automatically provide users of system 800 with recommended resolutions for their tasks. Task resolution engine 820 preferably includes a task-resolution matching module 822 and a task-resolution marketplace 824.

Task-resolution matching module 822 is operative to recommend resolutions for tasks entered into system 800. Preferably, task-resolution matching module 822 includes at least one of:

a contextual assistant 830 operative to recommend contextual resolutions for tasks, the contextual resolution of each task being contextually related to the task;

a personalization engine 832 operative to employ personal information pertaining to the owner of a task to recommend a personalized resolution for the task;

a task collaboration platform 834 operative to recommend collaborating between at least two individuals to resolve a task;

a task delegation engine 836 operative to delegate resolution of a task to an individual other than the owner of the task; and

a subtasking engine 838 operative to break down a task into at least two subtasks and to employ task-resolution matching module 822 to recommend a resolution for each of the subtasks.

Task-resolution marketplace 824 preferably includes a marketplace API 840 which facilitates external programmatic interfacing with task-resolution marketplace 824, a bidding platform 842 which facilitates bidding by service providers on providing services for resolving tasks, and a 3^{rd} party application module 844 which hosts 3^{rd} party applications for resolving tasks. Task-resolution marketplace 824 also preferably includes a 3^{rd} party service warehouse 846 which comprises information pertaining to 3^{rd} party services which system 800 may employ to resolve tasks.

As shown in FIG. 8, a user of system 800 utilizes a mobile device 850 to access system 800 to enter a task pertaining to planning a trip to New York into his task list. Preferably, the user is assisted in entering the task by auto-complete functionality 812 as described hereinabove with regard to the embodiments of FIGS. 1A-2B.

Preferably, upon submitting the new task, system 800 proceeds to employ semantic task analysis functionality 810 to provide a semantic analysis of the task to resolution engine 820 which in turn provides the semantic analysis to task-resolution matching module 822. Task-resolution matching module 822 employs contextual assistant 830 which, using the semantic analysis, ascertain that message 852 pertains to planning a trip to New York.

It is a particular feature of this embodiment of the present invention that subtasking engine 838 is operative to break down a task into subtasks and to employ task-resolution matching module 822 to recommend a resolution for each of the subtasks. It is appreciated that subtasking engine 838 may, for example, break the task down into subtasks based on the manner by which similar task have been broken down in the past. Additionally or alternatively, subtasking engine 838 may, for example, employ a crowdsourcing mechanism to provide one or more sets of suitable subtasks which together would be equivalent to the task.

In the example of FIG. 8, subtasking engine 838 recommends a task resolution which comprises several subtasks, such as ordering a flight, ordering a hotel, and renting a car. It is appreciated that task-resolution matching module 822 may employ any of the functionality described hereinabove in resolving each of the subtasks.

As shown in FIG. 8, upon resolving each of the subtasks, system 800 updates each of the subtasks as being completed on device 850.

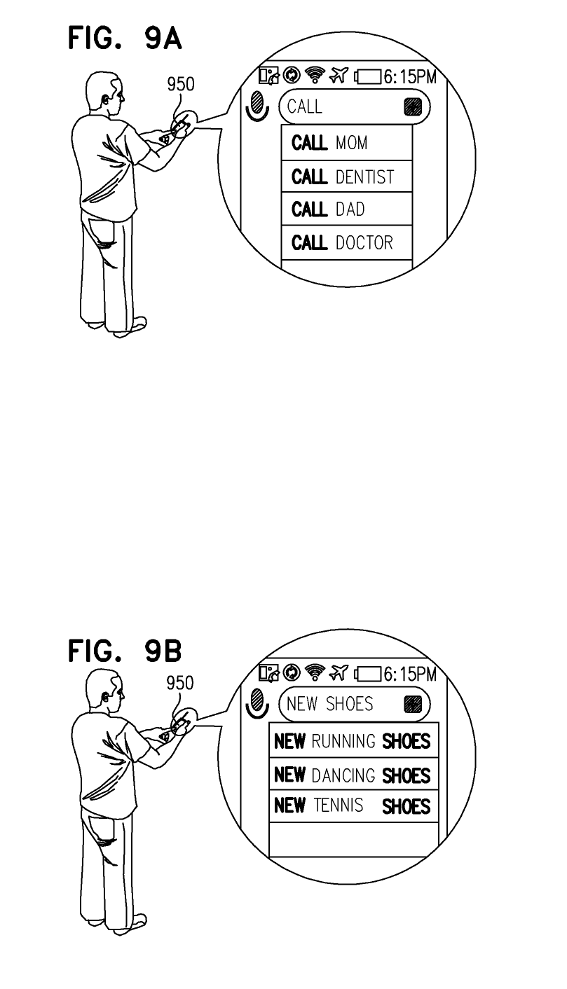

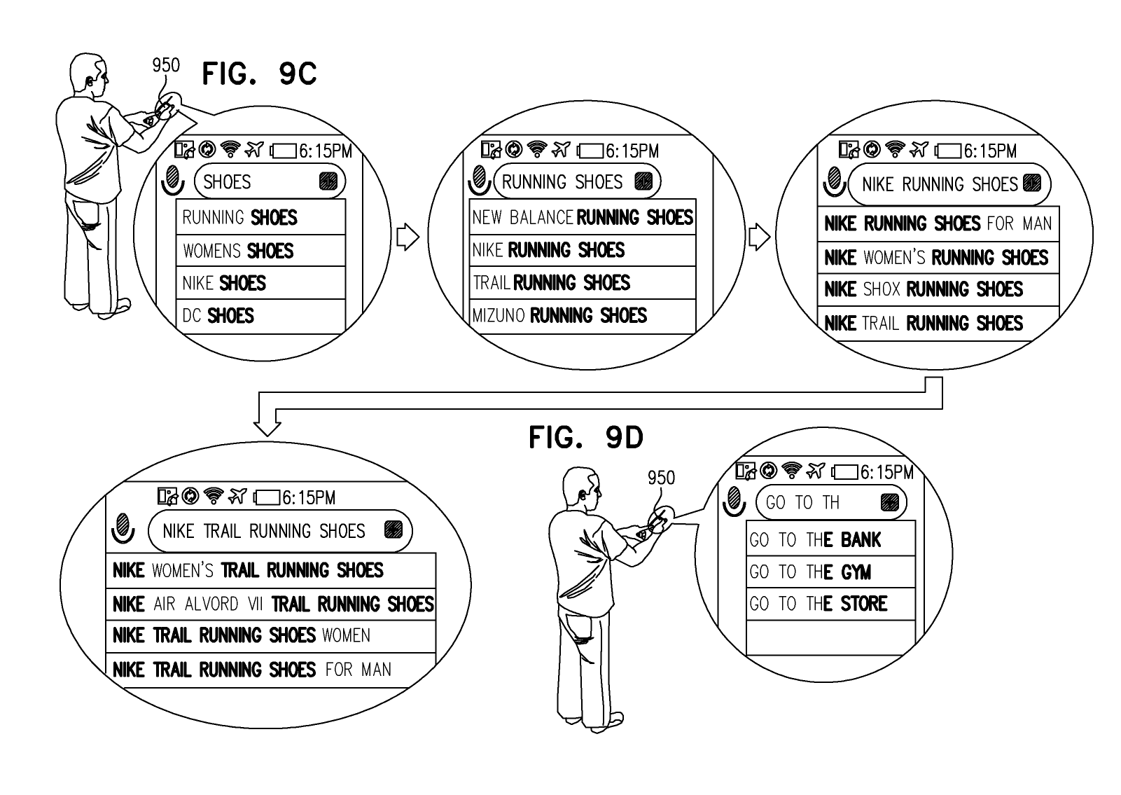

Reference is now made to FIGS. 9A, 9B, 9C and 9D, which are simplified pictorial illustrations of examples of auto-completion functionality which is part of the system of FIGS. 1A-8. As described hereinabove, the auto-complete functionality is preferably operative to employ the semantic analysis and\or tasks stored in the database to preemptively suggest complementary text to complete the textual description of the task.

FIG. 9A illustrates an automatic action-entity matching mechanism of the auto-completion functionality. As shown in FIG. 9A, a user of a mobile device 900 uses the system of FIGS. 1A-8 to enter a new task into the system. Responsive to the user entering an action, such as “call”, the automatic action-entity matching mechanism automatically matches the action of “call” to various entities which are typically called, such as the user's mother, dentist, father and doctor. It is appreciated that these entities may be entities which the user has called in the past as recorded in a task history of the user or entities that are commonly called by other users of the system. Entities may also be retrieved, for example, from the user's phone contacts, social network contacts, or from public contact directories such as telephone directories.

FIG. 9B illustrates using the task generator of FIGS. 1A-8 in conjunction with the auto-completion functionality. As shown in FIG. 9B, a user of mobile device 900 uses the system of FIGS. 1A-8 to enter a new task into the system, which task pertains to new shoes. As described hereinabove with regard to FIGS. 1A-8, tasks may be generated by the task generator based on information imported from external systems. For example, the task generator may import a list of products offered for sale on a web site and generate a list of tasks pertaining to the purchase of the products.

In the example of FIG. 9B, the auto-completion functionality is operative to contextually match the task entered by the user to a list of possible tasks generated by the task generator and to prompt the user to choose from the list of tasks. As shown in FIG. 9B, the auto-completion functionality suggests several types of shoes which may match the user's intent.

FIG. 9C illustrates an iterative mechanism of the auto-completion functionality. As shown in FIG. 9C, a user of mobile device 900 uses the system of FIGS. 1A-8 to enter a new task into the system, which task pertains to new shoes. As described hereinabove with regard to FIGS. 1A-8, tasks may be generated by the task generator based on information imported from external systems. For example, the task generator may import a list of products offered for sale on a web site and generate a list of tasks pertaining to the purchase of the products.

In the example of FIG. 9C, the auto-completion functionality is operative to contextually match the task entered by the user to a list of possible tasks generated by the task generator and to prompt the user to choose from the list of tasks. As shown in FIG. 9C, the auto-completion functionality suggests several types of shoes which may match the user's intent. Responsive to the user's choice of running shoes, the auto-completion functionality then suggests several particular brands of running shoes which may match the user's intent.

FIG. 9D illustrates a contextual-based mechanism of the auto-completion functionality. As shown in FIG. 9D, a user of mobile device 900 uses the system of FIGS. 1A-8 to enter a new task into the system. With each additional letter which the user types into the system, the contextual based mechanism repeatedly suggests possible complementary texts for completing the task definition based on personal preferences of the user, such as the user's location and task history. The user may then continue to type additional letters or to choose one of the complementary texts suggested by the contextual based mechanism to complete the task definition.

It will be appreciated by persons skilled in the art that the present invention is not limited by what has been particularly shown and described hereinabove. Rather the scope of the present invention includes both combinations and subcombinations of the various features described hereinabove as well as modifications thereof which would occur to persons skilled in the art upon reading the foregoing description and which are not in the prior art.

1. An automatic task management and resolution system comprising:
semantic task analysis functionality operative to provide a semantic analysis of at least part of a textual description of a task; and
task-resolution functionality operative to employ said semantic analysis to recommend at least one resolution for said task.

2. An automatic task management and resolution system according to claim 1 and wherein said task-resolution functionality is also operative to prompt an owner of said task to select one of at least one resolution for said task.

3. An automatic task management and resolution system according to claim 1 and wherein said task-resolution functionality is also operative to execute said one of at least one resolution for said task.

4. An automatic task management and resolution system according to claim 1 and also comprising a task database operable for storing task descriptions and metadata associated therewith.

5. An automatic task management and resolution system according to claim 1 and also comprising auto-complete functionality operative to employ said semantic analysis to preemptively suggest at least one complementary text to complete said at least part of a textual description of a task.

6. An automatic task management and resolution system according to claim 5 and wherein said at least one complementary text comprises a task predicate with whom an owner of said task has interacted in the past.

7. An automatic task management and resolution system according to claim 5 and wherein said at least one complementary text comprises a task predicate with whom an owner of said task is acquainted.

8. An automatic task management and resolution system according to claim 7 and wherein said auto-complete functionality retrieves said predicate from at least one of said owner's phone contacts, said owner's social network contacts and public contact directories.

9. An automatic task management and resolution system according to claim 5 and wherein said at least one complementary text comprises at least a refining term which refines said textual description of said task.

10. An automatic task management and resolution system according to claim 5 and wherein said auto-complete functionality is also operative to prompt an owner of said task to select one of at least one complementary text to complete said at least part of a textual description of a task.

11. An automatic task management and resolution system according to claim 1 and also comprising auto-complete functionality operative to utilize task descriptions stored in said database to preemptively suggest at least one complementary text to complete said at least part of a textual description of a task.

12. An automatic task management and resolution system according to claim 11 and wherein said at least one complementary text comprises a task predicate with whom an owner of said task has interacted in the past.

13. An automatic task management and resolution system according to claim 11 and wherein said at least one complementary text comprises a task predicate with whom an owner of said task is acquainted.

14. An automatic task management and resolution system according to claim 13 and wherein said auto-complete functionality retrieves said predicate from at least one of said owner's phone contacts, said owner's social network contacts and public contact directories.

15. An automatic task management and resolution system according to claim 11 and wherein said at least one complementary text comprises at least a refining term which refines said textual description of said task.

16. An automatic task management and resolution system according to claim 11 and wherein said auto-complete functionality is also operative to prompt an owner of said task to select one of at least one complementary text to complete said at least part of a textual description of a task.

17. An automatic task management and resolution system according to claim 1 and also comprising a statistics aggregator operable for aggregating task statistics.

18. An automatic task management and resolution system according to claim 1 and wherein said task-resolution functionality comprises at least one of:
a contextual assistant operative to employ said semantic analysis to recommend at least one contextual resolution for said task, said contextual resolution being contextually related to said task;
a personalization engine operative to employ said semantic analysis and personal information pertaining to an owner of said task to recommend at least one personalized resolution for said task;
a task collaboration platform operative to employ said semantic analysis to recommend collaborating between at least two individuals to resolve said task;
a task delegation engine operative to employ said semantic analysis to delegate resolving of said task to an individual other than said owner; and
a subtasking engine operative to employ said semantic analysis to break down said task into a set of subtasks and to employ said task resolution matching functionality to recommend a resolution for each of said subtasks.

19. An automatic task management and resolution system according to claim 18 and wherein said personal information comprises at least one of the location of said owner, preferred vendors of said owner and acquaintances of said owner.

20. An automatic task management and resolution system according to claim 18 and wherein said contextual assistant also employs information pertaining to the location of vendors, the price range of said vendors' merchandise, and overall past satisfaction with said vendors to recommend a contextual resolution for said task.

21. An automatic task management and resolution system according to claim 18 and wherein said personalization engine is operative to retrieve said personal information from social networks of which said owner is a member.

22. An automatic task management and resolution system according to claim 1 and wherein said task-resolution functionality also comprises at least one of:
a bidding platform operative to facilitate bidding by service providers on providing services for resolving said task;
a 3^{rd} party application module operative to execute 3^{rd} party applications operable for resolving said task; and
a 3^{rd} party service warehouse comprising information pertaining to 3^{rd} party services which said system may employ to resolve said task.

23. An automatic task management and resolution system according to claim 1 and wherein said system resides on a host server which is accessible via the internet.

24. An automatic task management and resolution system according to claim 1 and also comprising a task generator which is operative to automatically generate potential tasks for an individual.

25. An automatic task management and resolution system according to claim 24 and wherein said potential tasks pertain to the purchase of products advertised on the internet.

26. An automatic task management and resolution system according to claim 24 and wherein said potential tasks are identical to tasks which were created by users other than said individual.

27. An automatic task management and resolution system according to claim 1 and also comprising an application programming interface operative to facilitate programming interfacing with said system.

28. An automatic task management and resolution system according to claim 27 and wherein said application programming interface is also operative to receive email messages, to employ said semantic task analysis functionality to analyze the content of said messages and to provide a semantic analysis of potential task related elements of said messages to said task-resolution functionality.

29. An automatic task management and resolution system according to claim 1 and wherein said system is also operative to track actual resolution of said task.

30. An automatic task management and resolution system according to claim 1 and also comprising task element linking functionality operative to employ said semantic analysis to provide at least one actionable link for at least one element of said task.

31. An automatic task management and resolution system according to claim 30 and wherein said at least one actionable link is a link to a web page.

32. An automatic task management and resolution system according to claim 30 and wherein said at least one actionable link is a link to an application.

33. An automatic task management and resolution system according to claim 18 and wherein said contextual assistant is operative to provide optional actions which are contextually related to said task to an owner of said task.

34. An automatic task management and resolution system according to claim 33 and wherein said optional actions comprise at least one of:
online searching for a product;
online searching for a service;
online searching for a location of a product provider;
online searching for a location of a service provider; and
requesting directions to any of said locations.

35. An automatic task management and resolution system according to claim 18 and wherein said task collaboration platform is also operative to employ said semantic analysis to provide a recommendation to collaborate between at least two individuals to resolve said task.

36. An automatic task management and resolution system according to claim 18 and wherein said task collaboration platform is also operative to prompt an owner of said task to accept said recommendation.

37. An automatic task management and resolution system according to claim 18 and wherein said task collaboration platform is also operative to execute said recommendation.

38. An automatic task management and resolution system according to claim 18 and wherein said set of subtasks is identical to a corresponding set of subtasks which were created in the past to resolve a task identical to said task.

39. An automatic task management and resolution system according to claim 18 and wherein said subtasking engine is operative to employ a crowdsourcing mechanism to provide said set of subtasks.

40. An automatic task management and resolution system according to claim 22 and wherein said bidding platform is also operative to employ said semantic analysis to recommend resolving said task by hiring at least one of said service providers.

41. An automatic task management and resolution system comprising:
semantic task analysis functionality operative to provide a semantic analysis of at least part of a textual description of a task; and
task element linking functionality operative to employ said semantic analysis to provide at least one actionable link for at least one element of said task.

42. An automatic task management and resolution system according to claim 41 and wherein said at least one actionable link is a link to a web page.

43. An automatic task management and resolution system according to claim 41 and wherein said at least one actionable link is a link to an application.

44. An automatic task management and resolution system comprising:
semantic task analysis functionality operative to provide a semantic analysis of at least part of a textual description of a task; and
a contextual assistant operative to employ said semantic analysis to recommend at least one contextual resolution for said task, said contextual resolution being contextually related to said task.

45. An automatic task management and resolution system according to claim 44 and wherein said contextual assistant is operative to provide optional actions which are contextually related to said task to an owner of said task.

46. An automatic task management and resolution system according to claim 45 and wherein said optional actions comprise at least one of:
online searching for a product;
online searching for a service;
online searching for a location of a product provider;
online searching for a location of a service provider; and
requesting directions to any of said locations.

47. An automatic task management and resolution system comprising:
semantic task analysis functionality operative to provide a semantic analysis of at least part of a textual description of a task having an owner; and
a personalization engine operative to employ said semantic analysis and personal information pertaining to said owner of said task to recommend at least one personalized resolution for said task.

48. An automatic task management and resolution system comprising:
semantic task analysis functionality operative to provide a semantic analysis of at least part of a textual description of a task; and
a task collaboration platform operative to employ said semantic analysis to recommend collaborating between at least two individuals to resolve said task.

49. An automatic task management and resolution system according to claim 48 and wherein said task collaboration platform is also operative to employ said semantic analysis to provide a recommendation to collaborate between at least two individuals to resolve said task.

50. An automatic task management and resolution system according to claim 48 and wherein said task collaboration platform is also operative to prompt an owner of said task to accept said recommendation.

51. An automatic task management and resolution system according to claim 48 and wherein said task collaboration platform is also operative to execute said recommendation.

52. An automatic task management and resolution system comprising:
semantic task analysis functionality operative to provide a semantic analysis of at least part of a textual description of a task having an owner; and
a task delegation engine operative to employ said semantic analysis to delegate resolving of said task to an individual other than said owner.

53. An automatic task management and resolution system comprising:
semantic task analysis functionality operative to provide a semantic analysis of at least part of a textual description of a task; and
a subtasking engine operative to employ said semantic analysis to break down said task into a set of subtasks and to employ said task resolution matching functionality to recommend a resolution for each of said subtasks.

54. An automatic task management and resolution system according to claim 53 and wherein said set of subtasks is identical to a corresponding set of subtasks which were created in the past to resolve a task identical to said task.

55. An automatic task management and resolution system according to claim 53 and wherein said subtasking engine is operative to employ a crowdsourcing mechanism to provide said set of subtasks.

56. An automatic task management and resolution system comprising:
semantic task analysis functionality operative to provide a semantic analysis of at least part of a textual description of a task; and
a bidding platform operative to facilitate bidding by service providers on providing services for resolving said task.

57. An automatic task management and resolution system according to claim 56 and wherein said bidding platform is also operative to employ said semantic analysis to recommend resolving said task by hiring at least one of said service providers.

58. An automatic task management and resolution system comprising:
semantic task analysis functionality operative to provide a semantic analysis of at least part of a textual description of a task; and
auto-complete functionality operative to employ said semantic analysis to preemptively suggest at least one complementary text to complete said at least part of a textual description of a task.

59. An automatic task management and resolution system according to claim 58 and wherein said at least one complementary text comprises a task predicate with whom an owner of said task has interacted in the past.

60. An automatic task management and resolution system according to claim 58 and wherein said at least one complementary text comprises a task predicate with whom an owner of said task is acquainted.

61. An automatic task management and resolution system according to claim 60 and wherein said auto-complete functionality retrieves said predicate from at least one of said owner's phone contacts, said owner's social network contacts and public contact directories.

62. An automatic task management and resolution system according to claim 58 and wherein said at least one complementary text comprises at least a refining term which refines said textual description of said task.

63. An automatic task management and resolution system according to claim 58 and wherein said auto-complete functionality is also operative to prompt an owner of said task to select one of at least one complementary text to complete said at least part of a textual description of a task.

64. An automatic task management and resolution system comprising:
semantic task analysis functionality operative to provide a semantic analysis of at least part of a textual description of a task; and
auto-complete functionality operative to utilize task descriptions stored in said database to preemptively suggest at least one complementary text to complete said at least part of a textual description of a task.

65. An automatic task management and resolution system according to claim 64 and wherein said at least one complementary text comprises a task predicate with whom an owner of said task has interacted in the past.

66. An automatic task management and resolution system according to claim 64 and wherein said at least one complementary text comprises a task predicate with whom an owner of said task is acquainted.

67. An automatic task management and resolution system according to claim 66 and wherein said auto-complete functionality retrieves said predicate from at least one of said owner's phone contacts, said owner's social network contacts and public contact directories.

68. An automatic task management and resolution system according to claim 64 and wherein said at least one complementary text comprises at least a refining term which refines said textual description of said task.

69. An automatic task management and resolution system according to claim 64 and wherein said auto-complete functionality is also operative to prompt an owner of said task to select one of at least one complementary text to complete said at least part of a textual description of a task.

70. An automatic task management and resolution system comprising:
semantic task analysis functionality operative to provide a semantic analysis of at least part of a textual description of a task; and
iterative auto-complete functionality operative to employ said semantic analysis to iteratively suggest at least one complementary text to complete said at least part of a textual description of a task.

71. An automatic task management and resolution system according to claim 70 and wherein each iteration of said iterative auto-complete functionality suggests at least one complementary text comprises at least a refining term which further refines said textual description of said task.

72. An automatic task management and resolution method comprising:
providing a semantic analysis of at least part of a textual description of a task; and
employing said semantic analysis to recommend at least one resolution for said task.
